(19) United States
(12) Patent Application Publication
(10) Pub. No.: US 2015/0096768 A1
(43) Pub. Date: Apr. 9, 2015

(54) SHORT TERM TRANSPORT TOOLS FOR CRYOGENICS

(71) Applicant: Denyse Claire Dubrucq, (US)

(72) Inventors: Denyse Claire DuBrucq, Dayton, OH (US); Brian P. O'Leary, Huber Heights, OH (US)

(21) Appl. No.: 14/045,598

(22) Filed: Oct. 3, 2013

(51) Int. Cl. A62C 31/00; A62C 99/00

(52) U.S. Cl. CPC A62C 31/00; A62C 99/0018
USPC 169/46; 62/50.1

(57) ABSTRACT

This discovery provides means to move cryogenic liquids safely in circumstances not needing long term liquid state preservation, to:
reduce mass from current practiced cryogenic containments,
lower cost, making methods affordable, and
be disposable, if necessary.

Using liquid Nitrogen as the transport agent for Nitrogen gas in fire, crises and energy situations allows
expelling of foreign substances by both liquid and gaseous Nitrogen keeps both temperature and purity of the gas.
expanding quantity at evaporation to over 200 times volume, and
employing plastic materials properly constructed for rapid movement, thermal insulation, inclusion of electrical wiring and function in dead air space, and flow direction control using valves.

This allows fixed Nitrogen fire control systems, replacing water sprinkler systems, eliminating water damage and electrical arcing. Implementing cryogenic operations broadens with economical, reliable equipment and tools when long term retention of liquid state is not required.

### CROSS-REFERENCE TO RELATED APPLICATIONS

U.S. Pat. No. 7,631,506 entitled “Liquid Nitrogen Enabler” issued Dec. 15, 2009, Inventor, Denyse DuBrucq.

Applications of her uses of Liquid Nitrogen where items in this application apply include:

| | PUB. APP. NO. | Title | | filed |
|---|---|---|---|---|
| 1 | 20120002776 | Dry coolant for primary stage of nuclear reactors | 13/134,628 | Jun. 11, 2011 |
| 2 | 20100236284 | Preserving liquids in cryogenic processes | 12/383,586 | Sep. 23, 2010 |
| 3 | 20100146993 | Liquid Nitrogen Enabler | 12/592,578 | Jun. 17, 2010 |
| 4 | 20100006281 | Harvesting hydrocarbons and water from methane hydrate deposits and | 12/217,915 | Jul. 9, 2008 |
| | | shale seams | | |
| 5 | 20090079255 | Harvesting hydrocarbons from coal, shale, peat, and landfill seams | 11/903,346 | Jul. 10, 2007 |
| 6 | 20090016944 | Hydrogen generator, Carbon dioxide and sulfate captor | 11/825,992 | Jul. 10, 2007 |
| 7 | 20080283255 | Liquid Nitrogen enabler apparatus | 11/750,149 | May 17, 2007 |
| 8 | 20070089431 | Liquid Nitrogen enabler | 11/544,285 | Oct. 6, 2006 |
| 9 | 20040226301 | Liquid Nitrogen enabler | 10/437,538 | May 14, 2003 |

Marsar, Stephen, “Survivability Profiling: How Long Can Victims Survive in a Fire,” Fire Engineering, July 2010 Volume 163, No. 7, pp. 77-82.

DuBrucq, Denyse, “Nitrogen Article” unpublished—here presented as Appendix A.
Note: *Nitrogen capitalized means the double atom molecule of just Nitrogen atoms—N₂. Without capitalizing nitrogen the material can be any molecule containing Nitrogen atom(s) with other element atoms as well. Nitrogen is inert, won't explode or react. Other nitrogen molecules might explode, like TNT, Ammonium nitrate, while others like proteins are relatively stable but certainly processed metabolically by the body. Also, in the text, Figures and numbering is presented in bold type to separate it from text.

### BACKGROUND OF THE INVENTION

1. Field of the Invention

The invention relates to a method cryogenic transport, of disbursing tools to move or place, mainly liquid Nitrogen, to fire and crises locations and energy situations which have both low weight and low cost advantages when long term preservation of temperature or liquid state is not a factor.

2. Discussion of the Related Art

The sited related art is mostly for fires and is discussed in the prior continuation application Ser. No. 11/544,285. These patents include:

Volker et al. (U.S. Pat. No. 5,197,548) force sprays Nitrogen causing Nitrogen gas to increase in air rather than displace the air mixture with pure Nitrogen gas.

Bragg et al. (U.S. Pat. No. 3,830,307) similar to the Volker design.

Thompson (U.S. Pat. No. 7,258,172) is a fixed apparatus surrounding a well fire, not versatile to accommodate any type of fire.

Ross et al. (U.S. Pat. No. 4,129,431) is also such a unit as Thompson's.

The need has additionally arisen to have tools as piping which seldom carry cryogen or anything else, have a pleasing appearance so it can show on the walls of the interior of a building without noticeably destroying the décor when having Nitrogen fixed fire control installed as part of remodeling. Including batteries and safety lighting it can be purchased for dual purpose safety—night lights and fire protection.

Additionally, liquid Nitrogen applied in short term carriers which are light in weight, efficient in mass, and less costly can carry more cryogen to affect the circumstances than the heavy long-term retaining carriers which are also costly where recovery of these tools is essential and where the short term, less costly items can be abandoned if need be during the event with little economic loss.

Additionally, many of the applications require electronic actuators as would open valves, receive responses from sensors as smoke detectors and the like to make a workable system. Being able to include the wiring in the spaces between pipes, the insulating space, makes installation of the system a single operation task, not putting in the cryogen carriers and then the electrical or electronic controls.

Additionally, there is a need for rapid application which can best be implemented with short-term carriers with specific nozzle design to meet an immediate need as were one to work to prevent an explosive device from going off or to flood the ground where a natural gas or water pipe has broken to prevent explosion and allow safe digging to the leaking pipe and which then has the contents frozen to plug the flow to alleviate the danger and so repairs can be made so the system can be returned to service.

Additionally, were fire departments needing small quantities of cryogen to handle specific events as a flesh burning incident where the burn can be treated rapidly with liquid Nitrogen, small drop size release evaporating into Nitrogen gas which both ends the flames and cools the tissue to limit the sizzle destroying tissue. Using Nitrogen gas leaves no contamination of the tissue which can help the healing process and allows medical experts unobstructed observation of the wound needing treatment.

Additionally there is need to air drop Liquid Nitrogen such that a cryogenically cold cloud of pure Nitrogen gas can be drawn into a fire, abate a tornado or otherwise deployed to handle a situation needing fire control or cooling to subside a flow of inappropriate material, the automated control of the disbursal timing and the steering of the dropping container better insures the task is properly engaged in the event below.

Additionally there is a need to treat a space in a building, home or other environment with an inert gas at specific temperatures which done with hot air might ignite a fire or otherwise react with the contents of that space causing unwanted change while carrying out an act of relief as would be to remove insect pests as bedbugs where having the environment heated to just over 180° F. kills the insects, larva and eggs if held for enough time to complete.

Additionally, having a means to isolate the evaporation of liquid Nitrogen in a specific unit best preserves the coldness of the gas and provides means to control the cooling process even separating the low temperature condensing inclusions in a Nitrogen mixture as in extracting fuels where Carbon dioxide, Methane, and Oxygen and Argon can be solidified or condensed including Nitrogen in the liquid Nitrogen storage tank leaving Neon, Helium and Hydrogen for gas separation, Neon being the heaviest, and Hydrogen from Helium by diverting the Hydrogen to reducing reactions leaving Helium for the balloons and sale to industrial gas companies.

Additionally, the isolated evaporation of liquid Nitrogen can supply tubing systems with the cryogen to freeze water, lava or other material as might freeze the core of a levee to increase its strength in severe hurricane conditions, freeze a barrier and allow space for people to repair breaches in dams and dikes, freeze water stopping further flooding of a vessel preventing its sinking, and freezing fuels or other material in truck or train disasters to prevent spilling and release of toxins or polluting liquid that would contaminate the ground, waters and the air, and to solidify by rapid cooling lava flows protecting areas further down the flow route and, if planned right, can make a habitable space with in place pipes for water, fuels and electrical wiring.

### SUMMARY OF THE INVENTION

In accordance with the first aspect of the invention, a method of equipment design and production to safely transport cryogenic liquids from long term cold retaining storage or production points for liquid Nitrogen to the use location so the cryogen can be safely transported for the carrier and made at a cost that enables use of Nitrogen for fire and crises control and energy circumstances where long term preservation of the liquid state is not a factor, but weight and cost of the containers are highly important.

In accordance with the first aspect of the invention, these equipment items can be designed to serve specific circumstances of quantity transported, means of disbursal through perforated dispensing segments, some small, and some the length of the apparatus, fineness of drops released, and volume best needed for the event or transport mission.

In accordance with the first aspect of the invention, equipment items light in weight afford carrying more of the liquid they convey than the heavier, long term retention of liquid state units, while preserving the comfort of carriage by having the external surfaces of the equipment safe and comfortable to the touch.

In accordance with the first aspect of the invention, the equipment items can be carried with handles, belts, straps and ties so users like first responders in fires and crises can wear on their being a large volume of liquid Nitrogen in these light weight, reliable, safe and inexpensive carriers, and conveying vehicles as helicopters, trucks, cars, and carts can be fitted so as to safely carry these short term transport items enroute to events.

In accordance with a second aspect of the invention, a method of using liquid Nitrogen to flood and cool by dispensing liquid *Nitrogen as substantially small droplets for fast evaporation and applying Nitrogen gas to crises so that the crises are handled and ended.

In one use for the second aspect of the invention, a method of stopping breathing in man and other mammals by eliminating Oxygen in the air they breathe, which stops Carbon dioxide release in the lungs, the triggering mechanism for the breathing reflex. Resuscitation is immediate once Oxygenated air is available in the lungs from a few cycles of Artificial Respiration is applied to draw Oxygen into the lungs. There is time to apply restraints before bringing dangerous beings as wild animals or criminals back to consciousness and normal breathing.

In another use, the Nitrogen atmosphere is generated in defense against future explosions protecting those in the vicinity, as noticing the smell of Natural gas, and those working situations and operations for ongoing use of flammables to insure safety and purity of the chemistry.

In another aspect of the invention, having lighter weight containers to transport liquid Nitrogen, first responders are able to carry more liquid Nitrogen into an event being handled by Nitrogen gas gaining more control the same amount of physical exertion.

In accordance with another aspect of the present invention, a method having carriers for liquid Nitrogen with a choice of perforated release components allows the first responder to tailor the porting device to the disbursement needs of the event.

Only Nitrogen can be effective in these circumstances because of the homophobic nature of the Nitrogen molecule (N.sub.2, N₂). Whether in liquid or gaseous state, a mass of Nitrogen will expel other materials. In liquids, watching a blob of Liquid Nitrogen, I have seen white kernels and black masses accumulating but never mixing with or becoming a solute with Liquid Nitrogen the solvent. The white kernels are both ice—water frozen—or dry ice—Carbon dioxide frozen. Black kernels can be dirt, soot, anything that is carried by, but not mixed in with, Liquid Nitrogen. Watching Nitrogen gas clouds in an enclosure through a transparent wall showed Nitrogen cloud below the smoke layer. Applying a second course of liquid Nitrogen evaporating into Nitrogen gas, moisture on the ground condensed into clouds amid the Nitrogen and rose to be included in the smoke sector as the Nitrogen expelled the contaminating material. N₂, Nitrogen, is a snob no matter whether in liquid or gas state—it likes its purity expelling all else.

Gaseous Nitrogen as it is generated will stay in a homogeneous cloud of Nitrogen unless a disrupting wind of five miles an hour or stronger whips it into a mixture of air gases, as swirling in Oxygen, Argon, water, Carbon dioxide, and other components. It is this exclusivity, homophobicness, that allows the Nitrogen cloud to eliminate Oxygen from a fire, from breath intake, from combustion engines requiring Oxygen in the air mix, and from potential explosion situations.

Neither liquid nor gaseous Nitrogen conducts electricity so putting out spark gap ignition works effectively as when one floods a building with a discovered gas leak or flammable materials as in a methamphetamine lab. It also solidifies or gels greases and oils rather than splattering them as happens when water is poured on a burning oil spill. Electrical transformers are often insulated with heating or motor oil. Mar. 12, 2012 one of the two major transformers on the third floor of the five story parking garage behind the Hilton and Sheraton Hotels in downtown Boston started to burn. Rather than end the burn with four liters of liquid Nitrogen using the Nitrogen fire extinguisher, they called in two more fire units and seventeen hoses fed water into the two transformers displacing the insulating oil and causing the fire to spread throughout the parking garage burning all the vehicles and destroying the transformers. This caused three days of blackout in the Back Bay section of Boston covering one third of the city. These wonderful traits of liquid and gaseous Nitrogen make it possible to end crises without fear of changing the nature, the shape, the composition, or dissolving anything that is causes the crisis or stages the situation to initiate a crisis.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 shows a double walled piping with connectors between pipe sections and a reservoir for liquid Nitrogen which will retain 1/230^{th} the amount of liquid Nitrogen to flood the pipe with gaseous Nitrogen upon ending the passage of liquid Nitrogen through the pipe. This way, sealing the pipe with a one way valve to prevent air entry, there is no chance of condensation or contaminating air in the Nitrogen pipes. These pipes can comprise the structure of Fixed Nitrogen Fire Protection systems.

FIG. 2 shows the piping with the electrical components of both wiring and battery and lighting components in the between pipe air cavities which serve as dead air insulation keeping the pipes from becoming cold on the outside were liquid Nitrogen to pass through them.

FIG. 3 is a view of the piping structure with on/off flow valves with their activating wiring and batteries and lights.

FIG. 4 is a view of the pipe with electronics and connectors forming a 45 degree bend which will allow the liquid Nitrogen to flow without interruption to its destiny.

FIG. 5 shows a combination of two 45 degree angles making a full right angle turn, as going around a corner, but in the design allowing smooth flow of liquid Nitrogen.

FIG. 6 illustrates both a “Y” in the pipe and the on/off flow control sending the liquid Nitrogen in one direction and not both. These actions are programmed in with the opening and closing mechanisms controlled remotely by software, for a Nitrogen Fixed Fire Control System, to make the liquid Nitrogen go to where the fire is detected.

FIG. 7a illustrates two valve types, the on/off flow valve and the one way flow valve that keeps the pipe system flooded with pure Nitrogen gas. It also illustrates the perforated inclusions in the pipe system that allows the liquid Nitrogen to drop in drips like rain pulled by gravity as it evaporates forming the dense Nitrogen gas cloud. In this both valves are open and the liquid Nitrogen is flooding the perforated area of the pipe providing a “cryorain” of Nitrogen evaporating as it cools.

FIG. 7b illustrates the one way flow valve shut keeping the Nitrogen gas in the pipes and the perforated section empty.

FIG. 8a shows various configurations of a cryotank truck carrying liquid Nitrogen with pipes going forward and backward from a central located supply feeding both pipes. Side view shows the pipe feed and perforated pipes extending. The back view of the truck shows the wind direction carrying the just evaporated Nitrogen gas cloud into a fire. Once the fire is out, the flow stops. Another configuration of the truck with pipes is to extend them out from the truck to directly apply the cryorain to an event.

FIG. 8b shows the construction of the double pipe with the infused perforated section which will be permanently fused to both pipe components after a section of those pipes are removed to give space to the perforated section.

FIG. 8c shows the configuration of the truck with pipes extending outward from the side of the unit raining liquid Nitrogen over water where an oil spill upstream is contaminating the surface of the water. As the oil passes under the troughs, the cryogenic Nitrogen gas freezes the oil on the surface of the water and people with nets or skimmers pick up the solid oil chunks and put them in a receptacle where they melt and, covering the container, can be taken to market.

FIG. 9a shows another pipe configuration, which, when specially molded ends are fused onto the pipe midsection, form a dewar, a jug which safely contains liquid Nitrogen with illustrations of the stored or travel configuration and when in use pouring liquid Nitrogen through a perforated pan enabling the Nitrogen fire extinguisher.

FIG. 9b illustrates the cross section of a plastic version of the pan is shown with the perforated section having up-curled edges fitting in a short pipe configuration with a rounded top between pipe sizes.

FIG. 10a shows an inverted dewar unit flooding a drilling with Nitrogen gas. The opening has the insert with a narrow outlet bringing about a slow flow from the dewar.

FIG. 10b shows the container system for this slow flow from the dewar having a given volume, it is upright when empty, but as it fills it becomes top heavy and finally tilts emptying the liquid Nitrogen into a perforated pan below sending cryorain down the drilling giving pulsed exposures to Nitrogen gas at the bottom of the drilling or hole.

FIG. 10c shows the dewar, having been emptied, being configured for filling with the slow flow component hanging into the dewar and the filling tube in place putting the liquid Nitrogen in the bottom of the dewar so little evaporation occurs during the filling process. Also notice that the battery on the inner pipe is warmed so functions and the light is lit making it possible to locate the dewar when empty by seeing that light.

FIG. 11a shows an dewar empty with a ventilated cap in place and a handle enabling easy carriage with one hand. The handle attaches at the neck and base.

FIG. 11b shows a second type container, the pint peanut butter jar with an insert insulating the unit. The drill pattern is shown which were a 1/32 inch drill used, gives a fine spray with good distance. The cap is shown, the top of the insert as the opening hugs the jar top, and the jar with the insert installed and fused into place.

FIG. 11c shows the pint peanut butter jar and inner liner which holds liquid N₂.

FIG. 12a shows the empty dewar open with the handle attached with a ring at the neck and a fixed insert at the base. The cut across the piping indicates that the volume of the dewar can vary by the length of the pipe section. Thus with one set of pipes at a variety of lengths, dewars of many different volumes can be manufactured.

FIG. 12b shows the functioning peanut butter pint jar with 1/32″ holes drilled in the cap and the jar filled nearly to the top with liquid Nitrogen. With the top on, the jar is set horizontally and the liquid Nitrogen flies out over considerable distance and eventually the cryorain falls forming on evaporation the pure, inert, cryogenically cold Nitrogen gas cloud. This can end fires that are hard to access and its gentle coverage ends any clothing fires or flesh burns leaving no contamination from the fire suppressant.

FIG. 13a shows the peanut butter pint jar shooter used to control a clothing fire where the cryorain meets the fire, the Nitrogen gas cloud stops the burn and the person walks away from the encounter.

FIG. 13b shows the dewar and pan, Nitrogen fire extinguisher, ending the kitchen fire, and it will perform as well on a vehicle fire, gas or electric and even combined in an accident situation. Any burn victim can be saved with the illustrated peanut butter jar effort.

FIG. 13c shows the inverted dewar with the slow flow unit in place filling the fill and tip container which, when full, empties into the perforated pan and cryorain falls down the drilling in the ground. This is used both in coal mine fire control and in freezing the ground for fuel extraction and remediation.

FIG. 14 is the skeleton for the means to carry liquid Nitrogen aloft, the bucket.

FIG. 15 adds the superstructure carrier, motor operated by remote control to roll the bucket to disburse the liquid Nitrogen through a perforated plate and connector to the cable from the aircraft, helicopter, which carries the load to the target location.

FIG. 16a includes the double walled containment for the liquid Nitrogen allowing the pipe separated bowl structures, the filling pipe and cap, here the filling of the bucket.

FIG. 16b shows the remote control device which is in hands of pilot or controller.

FIG. 16c illustrates the filling tube and cap with air gap top and bottom.

FIG. 17a shows the helicopter with the bucket on the cable carrying a volume of liquid Nitrogen, and, in illustration of expansion, the 230 volumes of Nitrogen gas it creates by evaporation for use in handling crises and fires.

FIG. 17b illustrates the bucket disbursing the liquid Nitrogen when rotated on the axis to have the perforated plate down and the cryorain shown leaving the bucket.

FIG. 17c is the remote control device that is either in the cockpit of the helicopter or operated by the ground observer so the drop of liquid Nitrogen meets its target.

FIG. 18 shows a treatment containment where the space is boxed off and Nitrogen gas is sourced from liquid Nitrogen, heated, and enters the space displacing the air. This space can contain furnishings and rugs in the space to heat to the lethal temperature for such pests as bedbugs, fleas, placing the space in sequence throughout the infested area. This illustration shows the startup of the unit with the valve feeding from the liquid Nitrogen source as the Nitrogen gas displaces the air inside the double material walls and the air leaving the circulation system.

FIG. 19 shows the space heating unit expanded in height and in full operating configuration with the valve allowing the Nitrogen gas in the space to recirculate through the heater unit and continue to bring to temperature and remain at desired level. The fluid heated by the electric heating unit contains water for temperatures through 200° F.

FIG. 20 shows a motor driven evaporator with a pipe to feed liquid Nitrogen into a drum with a rotating perforated paddle set through which the liquid Nitrogen rains and evaporates forming the Nitrogen gas cloud, pure, inert and at cryogenic temperature.

FIG. 21 adds the Nitrogen to the evaporator where cryorain evaporates into the Nitrogen gas cloud which feeds out through a liquid barrier and out, here, two pipes. This tool enables the freezing tasks to prevent flooding and lava invasion downstream, implementing fossil fuel engine vehicle stoppage, and fuel separation efforts in remediation, flaring fuels capture, and fuel extraction from oil shale and landfill seams.

FIG. 22a appears like a calliope, but rather than breathy music, separates fuels extracted from the ground and heats the Nitrogen gas entering the extraction zone at the center through the two pipes originating at the evaporator after cooling down the Nitrogen and fuel mixture coming from the ground. It also liquefies the Nitrogen purified in the process of condensing the fuels and other gases. This configuration in full handles fuel extraction processes and abbreviated the flaring abatement handling only ethers and the light gases, and in remediation, depending on what is being removed, that aspect of the thermal spectrum presented here. It also separates the contaminants from nuclear material disintegration in primary reactors where Nitrogen is the coolant.

FIG. 22b shows the cross section of the condensing pipe with the two smaller pipes carrying evaporated Nitrogen gas and the larger pipe having the Nitrogen mix gas and condensed fuel and water, here ethers and water, which empty in the ether/water separator in FIG. 22a.

FIG. 22c includes the use of the double pipe as a carrier for two gases, here ethers in the center pipe and, inside the outer pipe, a mix of Oxygen and Argon. This fuels the burners providing both the fuel and the heat enhancing Oxygen for a hotter burn. A mite of Carbon dioxide is emitted, but it is safer and better than having the volatile ether gases handled for sale. Burners heat both the central drilling Nitrogen pipes entering the extraction zone center and the auxiliary locations throughout the extraction zone. The Ethers are separated from water in the separation tank with the tall perforated float which is lighter in mass than the water and heavier than the ether mixture.

FIG. 22d illustrates the auxiliary drilling warmers for Nitrogen gas using ether fuel heated in Oxygen rich Oxygen and Argon mixture sourced from well.

FIG. 23 shows an indoor fire in a building with Fixed Nitrogen Fire Control and a first responder coming to the scene carrying as much liquid Nitrogen as he or she can.

FIG. 24a shows the indoor fire a few minutes later with the effect of the Fixed Nitrogen Fire Control seen to nearly end the fire. What can the first responder do?

FIG. 24b illustrates details of the long, invertable dewars in backpack.

### DETAILED DESCRIPTION OF THE PREFERRED EMBODIMENTS

### A First Embodiment of the Present Invention

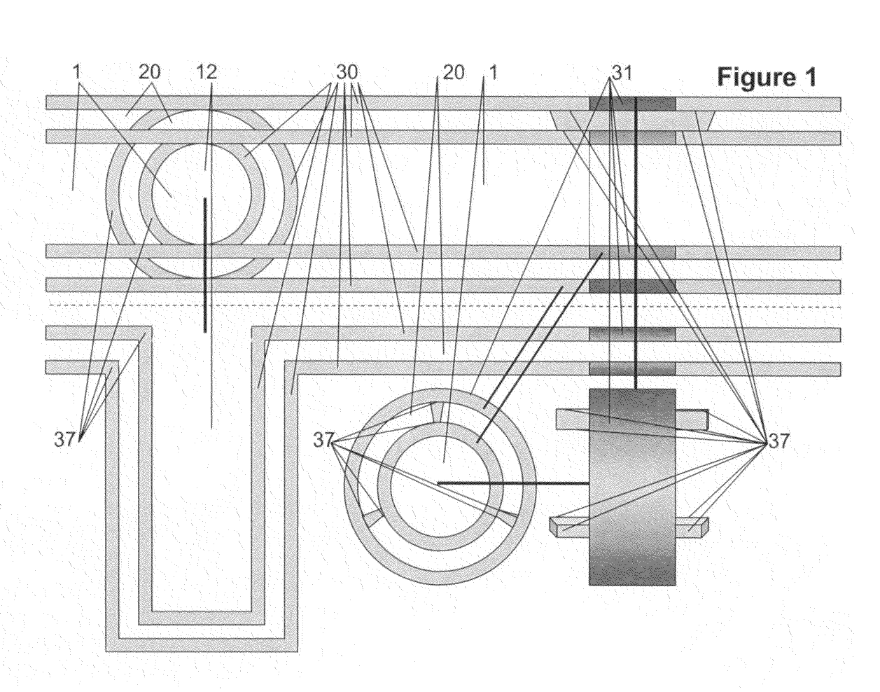

Turning now to the drawings and initially to FIGS. 1-8, shows the narrow double pipe details as would be applied in Nitrogen fixed fire control and pipe transfer of liquid Nitrogen. It includes special features like connectors between sections of pipe, containment for liquid Nitrogen to fill the pipe with Nitrogen gas after a flow, valves for allowing and stopping the flow and for one-way flow of the liquid Nitrogen and the perforated section allowing the formation of cryorain, the falling droplets of Nitrogen which evaporate liberating the pure, inert, cryogenically cold Nitrogen gas in clouds.

Turning now to FIG. 1, two pipes 30 are used to provide the safe liquid Nitrogen transfer, the smaller pipe carrying the liquid Nitrogen and the larger providing the “dead space” 20 for insulation. To insure these pipes do not get contaminated with air, the vertical pipe sections hold enough liquid Nitrogen from a flow to flood the pipes with Nitrogen gas 1. The length of the stored Nitrogen to fill pipes 12 must be 1/230^{th} the length of the pipe installed to insure more Nitrogen flows from the evaporating liquid Nitrogen. For every 120 feet of pipe, a stored Nitrogen insert of just over six inches is required. Also, when assembling a long pipe system as for Nitrogen fixed fire control, pipe sections must be connected with reliable fused seams 37. The connector 31 has the pipe end fusing area and extensions into the insulating space 20 between the pipes. Solid lines identify the inner pipe in the cross section and the inner pipe side view in the pipe representation 30 at the top of the page. A dotted line separates the second rendition of the lower pipe representation inserting the stored N₂ units 12. A bold line identifies the cross section and side view renditions of that feature.

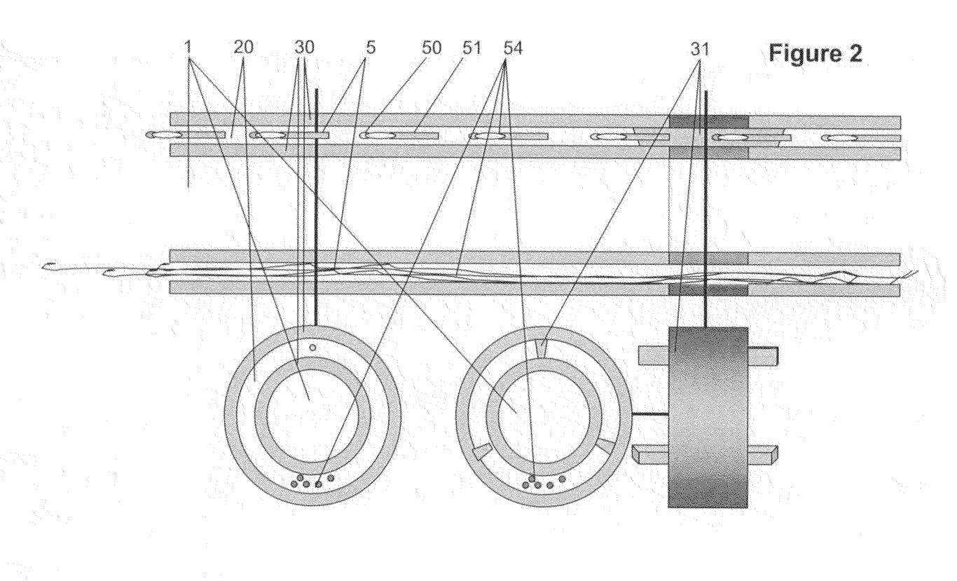

FIG. 2 highlights the electronics in the pipe system 30 with the connector 31 and, included in the parallel pipe spacing 20, wiring 54 is passed along the piping and lighting is accommodated with the LEDs or other light source 50 and the solar batteries 51 connected with wiring 54. Nitrogen gas 1 is in the center, inside the smaller pipe 30.

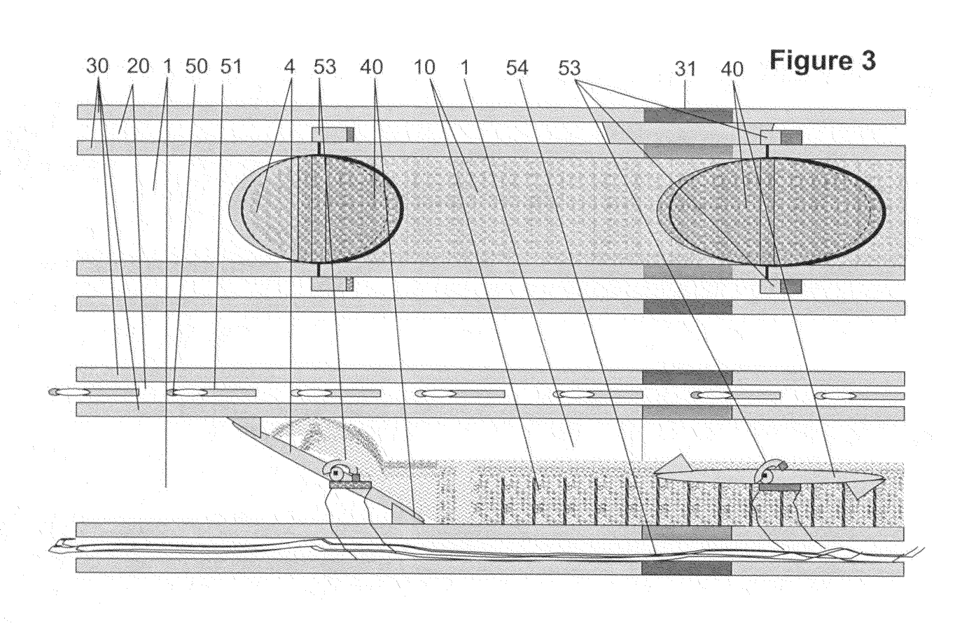

Turning now to FIGS. 3 through 8 where pipe configurations and valve flow control are shown, FIG. 3 presents two views, top and side views of the double pipe sets 30 with the insulating space 20 and the Nitrogen gas 1 and liquid Nitrogen 10 areas controlled by valves 4, the off/on flow valves 40. These valves are controlled by valve motion circuits 53 where, here an electrical magnet off leaves the valve allowing flow of the liquid Nitrogen and, on, changing the angle of the valve to diagonal stopping the flow of the liquid Nitrogen 10. Electrical components, wiring 54 and lamps 50 and batteries 51 are shown.

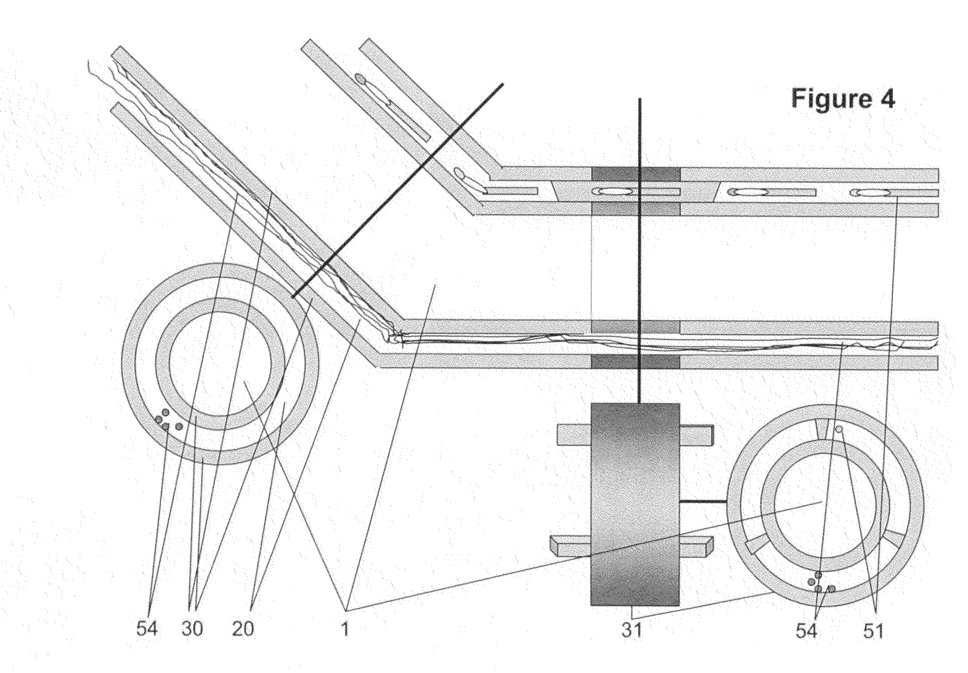

FIG. 4 shows the 45° bend in the pipe configuration with the double pipes 30, connector 31, with wiring 54 and battery 51 in the insulating space 20 and the Nitrogen passage 1 through the inner pipe. Because liquid Nitrogen flows like Mercury, having a 90° bend in the pipe will cause as much reflecting back of the liquid as passage; however, using the 45° bends prevents the deflection and allows the full amount of liquid to pass.

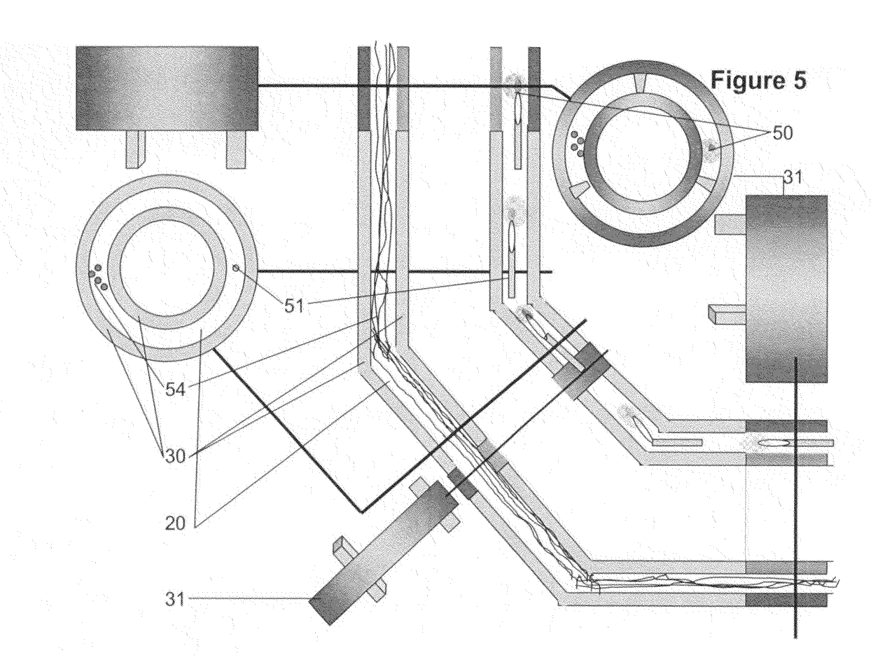

FIG. 5 illustrates the double 45° bends making the 90° turn as one would have rounding a corner of a building. Each bend making the 90° turn is a separate section of the pipe 30 requiring three connectors 31. In the insulating space, the electronics show lights on with lamps 50 lit powered by the solar batteries 51 and the wire 54 passage. Bold lines indicate ties from the side view of pipes at those locations to cross sections. This lighting feature allows visible fixed fire control piping to supply night lights.

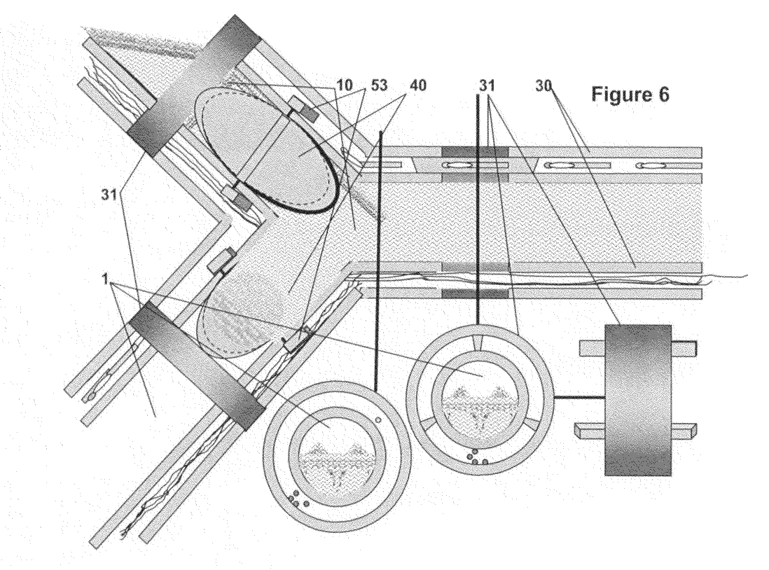

FIG. 6 illustrates both the “Y” division of flow of liquid Nitrogen and the valve action selection of the direction of flow, again taking three connectors 31 for the one part. The liquid Nitrogen 10 flows where the off/on valve 40 is horizontal and stops flowing in the direction where the off/on valve 40 is diagonal. This is executed by the valve motion element 53. Wires 54 continue from the origin in both directions through the pipes 30.

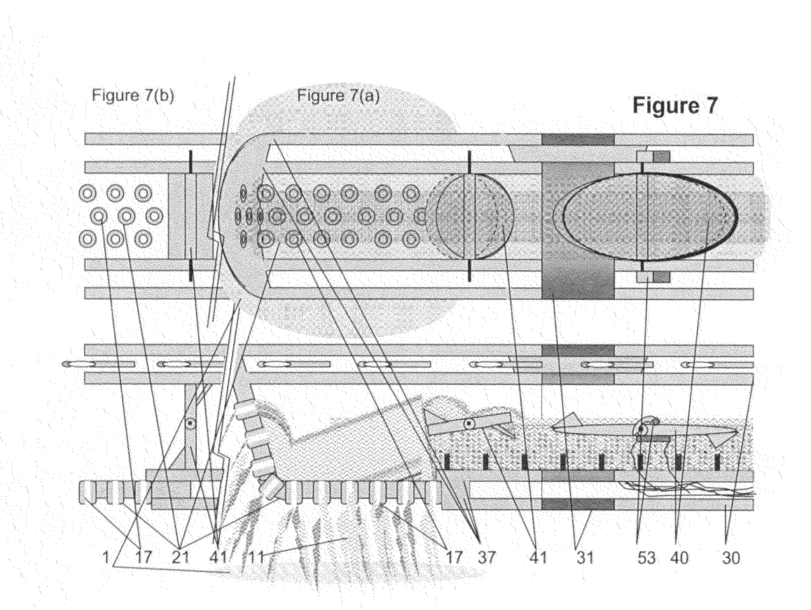

FIG. 7a completes the components of the pipe system adding the perforated section 17 allowing the liquid Nitrogen 10 to rain in droplets, cryorain 11, to apply the cooling fire suppressant Nitrogen gas 1 to the situation and the one way valve 41. With one connector 31, this change in operation is enabled. The perforated section is molded 21 held into place with fused seams 37. Before the junction, the double pipe 30 contains the off/on valve 40 and its controlling unit 53. The one way valve 41 needs no electronic control since the lower section edge expansion is heavier than the top edge expansion. The length of the perforated surface 17 varies with the application needed. These short pieces as illustrated would be appropriate for Fixed Nitrogen Fire Control Systems while longer versions, even 20 feet or more meet the needs of oil spill pickup and placing Nitrogen gas in fire drafts from off a mobile cryotank or cryotank truck.

FIG. 7b shows, referring to FIG. 7a, the one way valve 41 closed when there is no liquid Nitrogen 10 flow in that area preserving the Nitrogen gas atmosphere in the pipes 30. Note the lighting can continue into the perforated 17 region which during night operations can be useful in locating the pipe and Nitrogen release location.

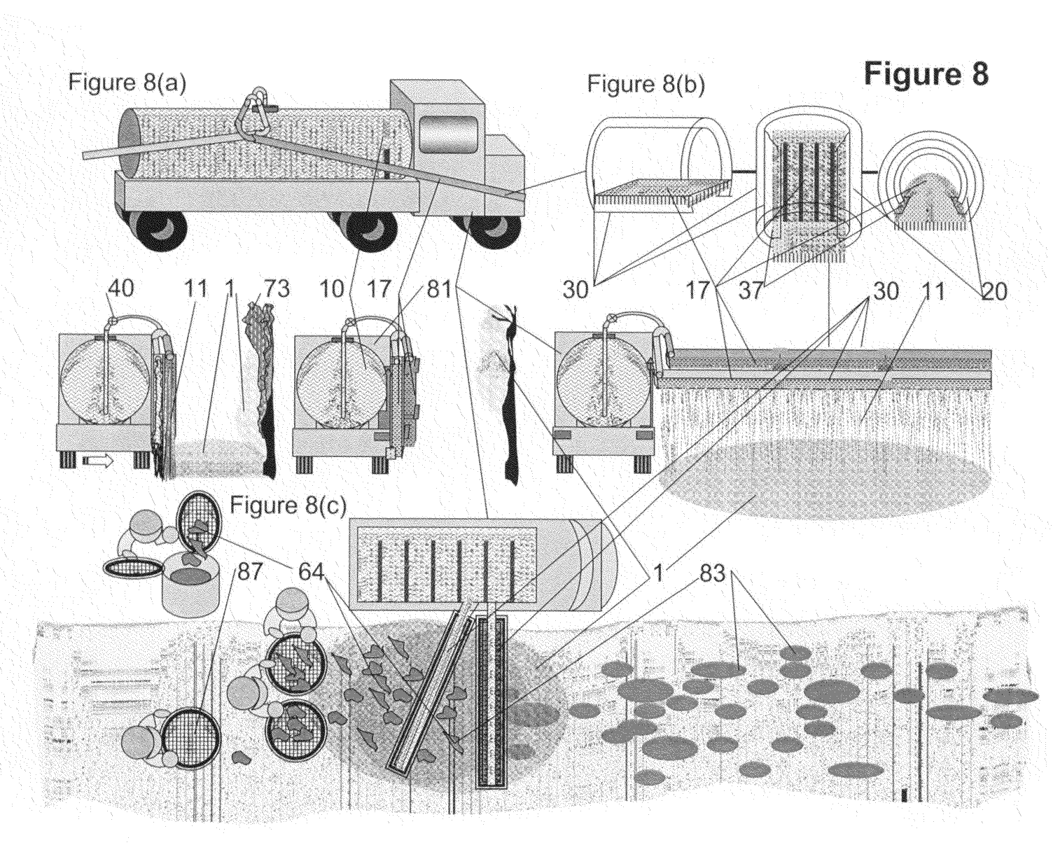

FIG. 8a illustrates means of using the pipe system 30 on cryotank trucks 81 filled with liquid Nitrogen 10 to carry the function to the field, the roadways. The truck side view is shown above and below, the rear view of the truck and, in FIG. 8c, the top view of the truck. The rear view of the truck is shown in a fire draft where the on/off valve 40 is opened so the liquid Nitrogen flows into the perforated troughs 17 releasing cryorain 11 evaporating into Nitrogen gas 1 that encounters the fire 73. The next view to the right shows the fire out so the valve 40 stops the flow of liquid Nitrogen and only the remaining cloud of Nitrogen gas 1 eliminating the burn in the treetops. Last in the sequence is the truck 81 with the perforated pipes 17 extending outward dropping cryorain 11 which evaporates into Nitrogen gas 1.

FIG. 8b shows the details of the perforated section 17 of the pipe 30 which are connected by fused seams 37 preserving the insulating spaces 20 where there are no perforations for handling. Side and top views are provided along with the cross section.

FIG. 8c gives a use illustration for the extended perforated 17 pipes 30 showing a stream contaminated with a fuel spill 83 where the fuel floats on the water and, on passage under the cryorain 11, the Nitrogen gas 1 freezes 64 the fuel 83 so people can collect the fuel as solids with skimmers or nets 87 and place it in barrels to carry away.

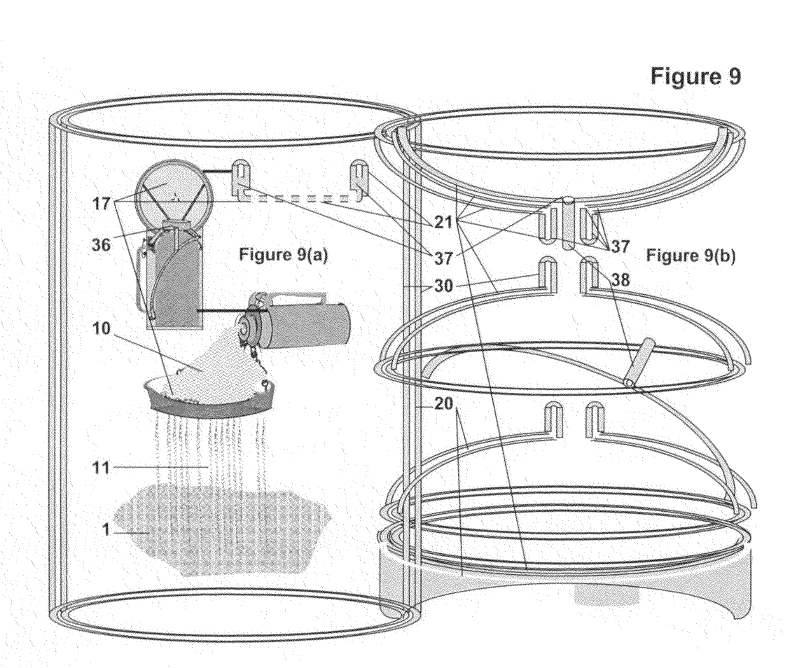

The second embodiment of the present invention uses pipes of wider dimension to make containers to carry liquid Nitrogen to events illustrated in FIGS. 9-13.

FIG. 9a illustrates the Nitrogen fire extinguisher using a dewar unit and pan made of large pipes 30 with the insulating spacing 20 fused to a top and bottom to meet the need and with pan, pipe components 30 with molded top 21 and a perforated bottom 17 fuse seamed 37 together. In storage compartment, the dewar is filled with liquid Nitrogen and capped with a ventilated cap 36. The pan is hung behind it. In use, it is taken out, the cap 36 removed, and where the treatment is needed, the dewar unit is tipped to pour the liquid Nitrogen 10 into the pan 17 which creates cryorain 11 evaporating into a cloud of Nitrogen gas 1 ending the fire or solidifying the spill.

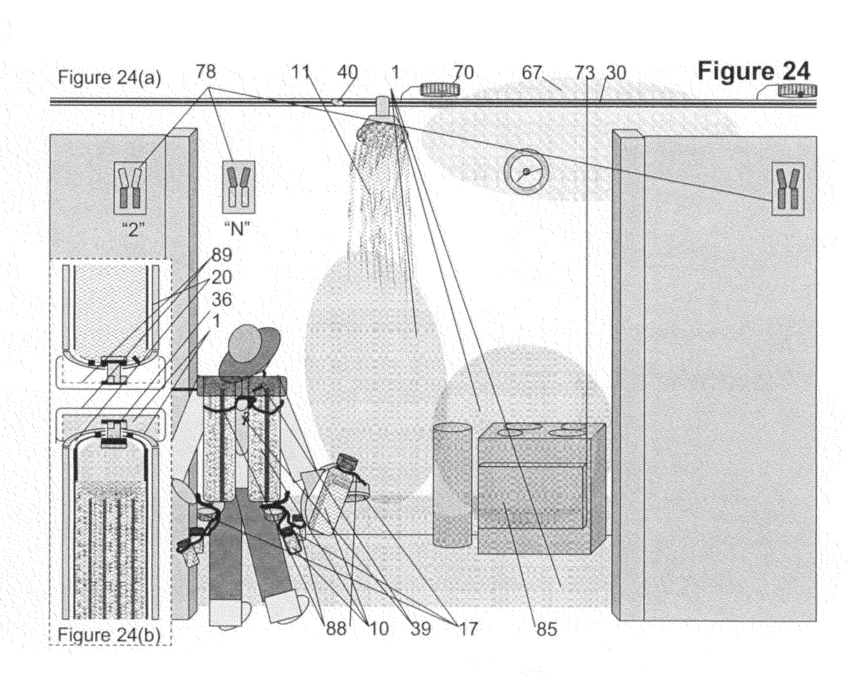

FIG. 9b shows the large pipe 30 section with the insulating space 20 to the left, and, to the right, various tops and a bottom to the dewar unit which will be made with fused seams between the pipe section and the top and bottom. On the right, the top unit is a top component and insert, both molded components 21 with the slow-flow small outlet 38 in place to slowly disburse the liquid Nitrogen into underground space. A ventilation means for dewars used in inverted orientation is illustrated in FIG. 24b. The next top shows the broader opening upward with the slow flow unit 38 lower in the space allowing the dewar to be filled. The third top is for normal upright use with the molded unit 21 having the insulating space 20. Last is the three footed base molded unit 21, having insulating space to keep the base at ambient temperature as the rest of the unit.

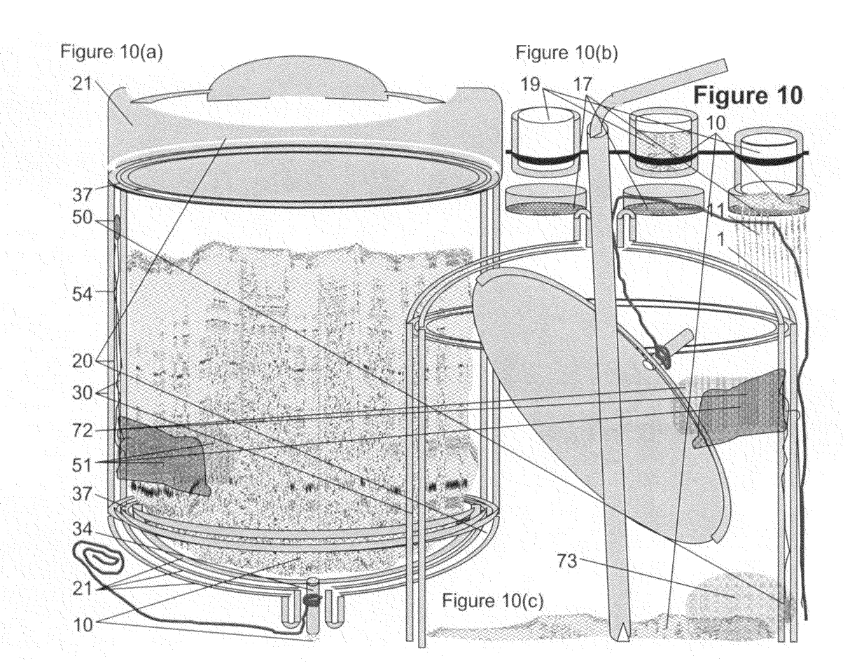

FIG. 10a shows the dewar structure 30 with the slow flow 38 unit in place for underground disbursement of Nitrogen 10. The molded parts 21 are indicated with the fused seams top and bottom of the pipe unit 30 with the insulating spaces 20 including electronics of a solar battery film 51 on the outside of the inner pipe and wires 54 extending to a lamp bulb or LED 50 which is not lit when the container is filled with liquid Nitrogen 10, but, shown on the right, when empty, the battery reaches warm temperature enough to function and the lamp 50 illuminates. This will allow finding the units in the dark and knowing when they are empty. The slow flow unit 34 is in place allowing the liquid Nitrogen 10 to fill a unit below it slowly giving pulsed servings of Nitrogen gas down the drilling.

FIG. 10b shows the tip and spill container 42 that catch the slow flow liquid Nitrogen 10. It has an axis low on the container 42 so when it is filled with more above the axis than below, it tips emptying into the perforated pan 17 causing the cryorain 11 which evaporates as it falls forming the Nitrogen gas cloud in the drilling base.

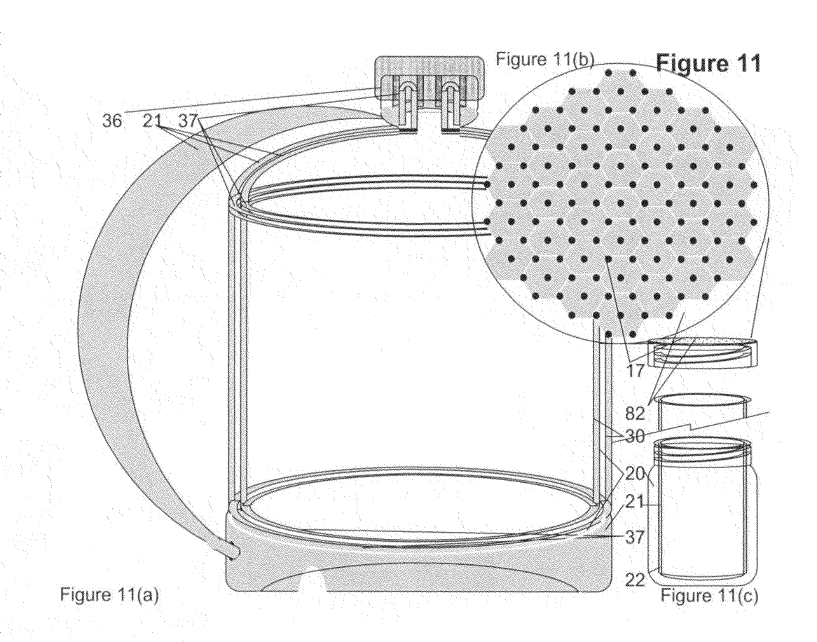

FIG. 11a shows the dewar unit 30, empty and upright with the ventilating cap 36, molded components 21 of the top and handle unit that catches around the opening pipe unit and is attached at the drilling in the base component. Seams are fused 37 around the top fitting to the wide pipe pair 30 and around the opening pipe and its top bevel and around the pipe to base junction. This, made of plastic, will be durable and light weight allowing carriage of more liquid Nitrogen for the same effort as the current metal dewars with the long retention of the cold liquid Nitrogen. However, for short term movement of cryogenic liquids, long endurance of the contents is of little importance, but weight is.

FIG. 11b shows the drill pattern for the cap 82 of a pint peanut butter jar. The diameter of the drill determines the range of sending the liquid Nitrogen 10 as cryorain 11 before it drops to the ground evaporating into a Nitrogen gas cloud 1.

FIG. 11c illustrates the commercially available pint peanut butter jar 22 fitted with the molded lining 21 which fits inside the jar with the rim extending to hold the insert 21 above the bottom of the jar to retain the insulation space 20 keeping the jar at ambient temperature even with the insert 21 filled with liquid Nitrogen 10 at −195.8° C. The cap 82 is drilled, perforated 17, with a recommended 1/32^{nd}″ drill for best thrust.

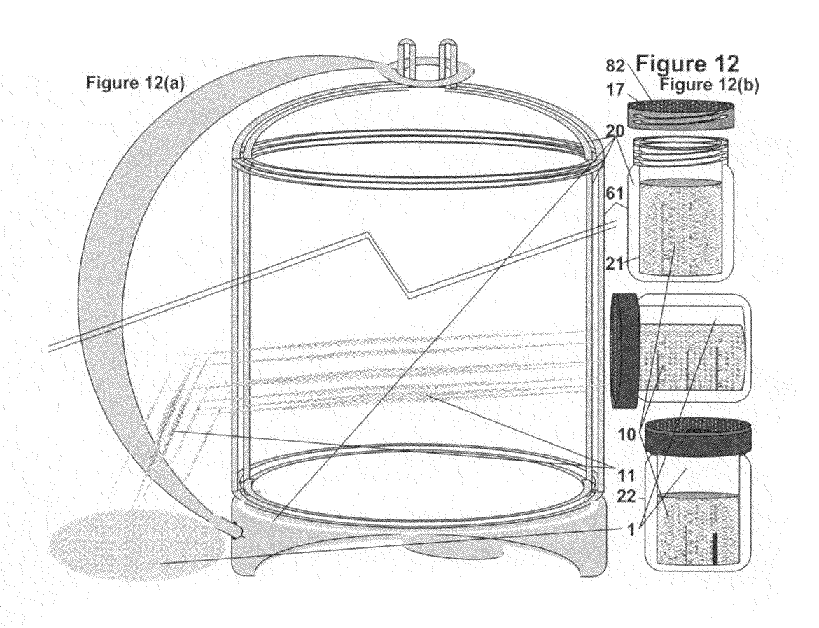

FIG. 12a shows the dewar from FIG. 11a, but the height of the pipe section 30 can vary depending on the volume of liquid Nitrogen wanting to be ported and used at the task site. This can be carried by hand, used as a backpack carried item, or ported in a conveyor as a wagon, vehicle, or even helicopter filled to use at the destination crisis. No frost or icing 61 should form on the dewar with the insulating space 20 isolated in place.

FIG. 12b illustrates the peanut butter jar 22 with insert 21 and perforated 17 cap 82 filled with liquid Nitrogen 10. When the jar 22 is held horizontally, it throws the cryorain 11 a distance to form the Nitrogen gas cloud where one might not be able to access. This delicate applicator uses little liquid Nitrogen targeting its crisis, be it a place of low ceiling or a person encountering the fire on his or her person. This can be most useful in situations like vehicle accidents where vehicle occupants are on fire. It is the perfect fire extinguisher for electric vehicles and for fuel driven vehicles since it does not arc electricity or lift burning fuel as water does in these instances spreading the fire on the fuels floating on the water and carrying the burn, or being ignited by water's arcing of electricity.

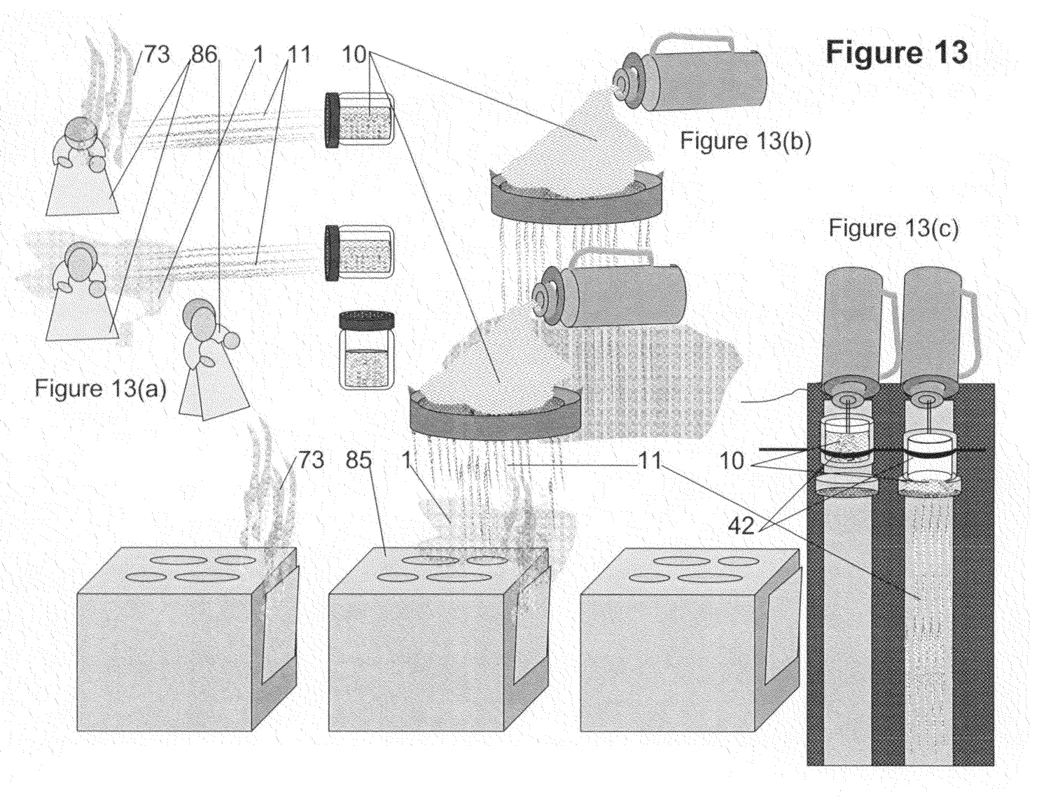

FIG. 13a illustrates the use of the peanut butter jar quickly ending the personal burn experience, fire 73. With Nitrogen fire extinguishing, the burned tissue is not corrupted with the fire suppressant material because the Nitrogen gas 1 just goes off into the air and, being an inert substance, it does not react with tissue or fuel components.

FIG. 13b shows the dewar item handling an oven fire 73 where burning food and the heating fuel or hot electric unit 85. The Nitrogen gas 1 is useful for quelling vehicle fires in this manner as well. A four liter dewar holds enough liquid Nitrogen 10 to fill the volume of a twin bed as Nitrogen gas 1. Knowing the expansion, the first responder can calculate how much liquid Nitrogen would be needed to handle the situation one faces.

FIG. 13c illustrates embedded fire control procedures and that for freezing the ground to protect the underground from fuel being extracted and to not lose the fuel evaporated to the ground, but rather bring it all to the surface to collect, separate and carry to market. The dewar unit with slow flow insert fills the fill and tip unit 42 sending periodically the cryorain 11 down the drilling to cool the ground at the base of the hole.

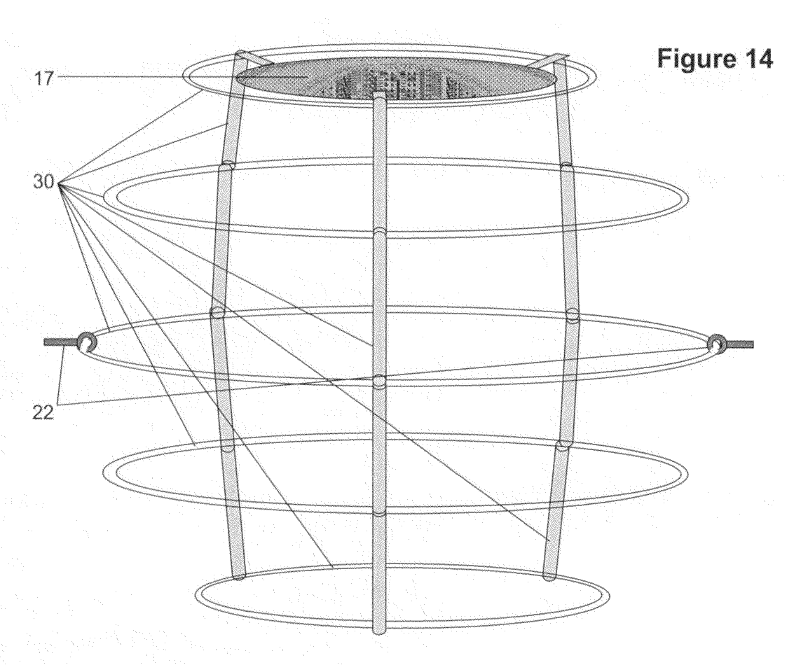

A Third Embodiment of the Present Invention enables a large quantity of liquid Nitrogen to be taken aloft lifted by helicopter and in flight disburses Nitrogen. FIGS. 14-17 show the “bucket” carried by helicopter to disburse liquid Nitrogen into fire drafts and for other causes to handle fires and crises.

FIG. 14 shows the skeleton of a light weight bucket with circular piping 30 spaced with a framing piping, again 30, with the largest hoop welded with to “eye” units 22 encircling that tubing and with a cylinder extending to fit in roller bearings to allow inversion of the bucket in flight. The top hoop encircles a smaller perforated plate 17.

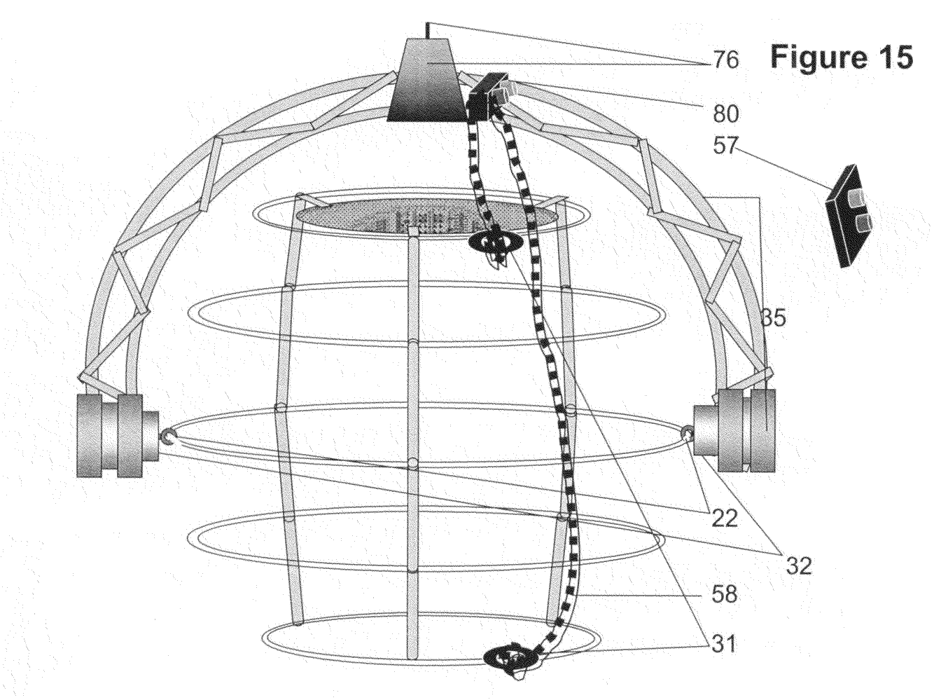

FIG. 15 adds a control unit allowing the “eye” units 22 inserted in the roller bearings 32 holding the bucket in the installed components 35 with bearings seats and connecting to the lift with scale unit 76 which attaches to the helicopter. Also shown is the orientation control unit with motor 80 moving the chain 58 with connectors 31 on the top and bottom hoop allowing inversion of the bucket from containment to release of content. Motor 80 has a remote control device 57 allowing orientation change from afar, either cockpit control or ground observer control of the disbursement timing.

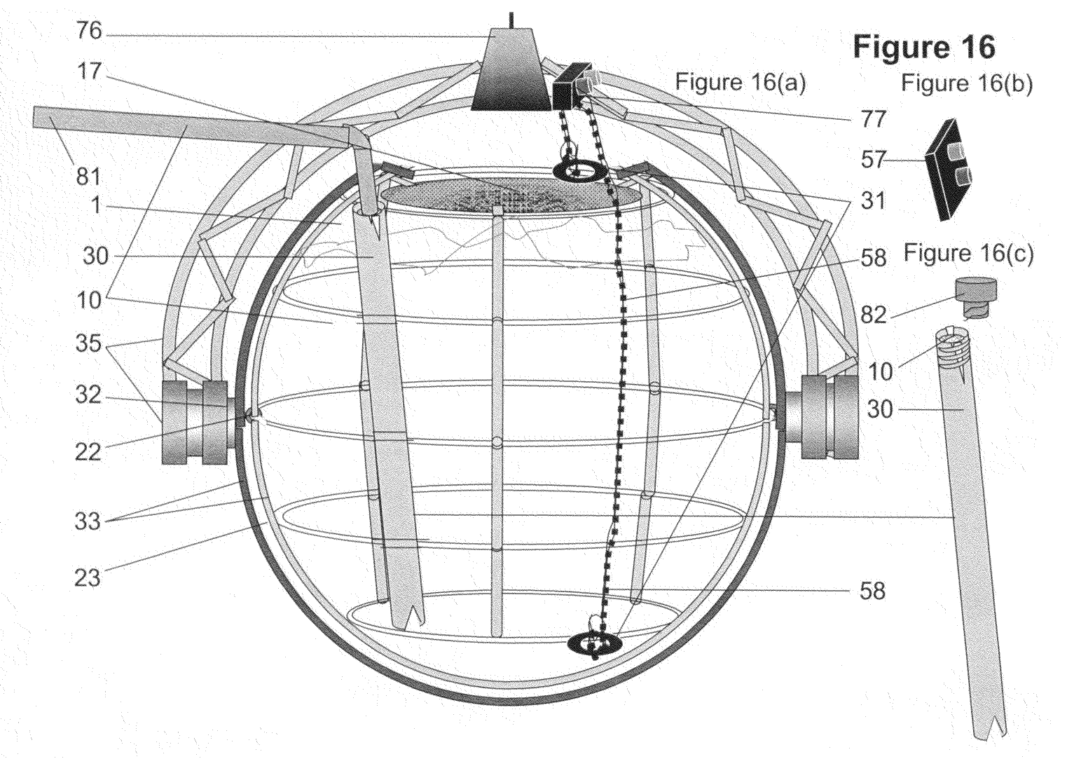

FIG. 16a adds the liquid Nitrogen containment with the seamed materials 33 comprising the inner and outer skins on the loop structure which will contain the liquid Nitrogen 10. These skins connect to the perforated plate 17 top and bottom to sew it into the system connecting the skins 33 to the plate 17 by a circle of thread or wire passable drillings around the periphery of perforated plate 17. The plate provides, in this orientation, closed base down, means to vent evaporated Nitrogen gas 1. The splashing surface of the liquid Nitrogen 10 as shown by the erratic purple line keeps the Nitrogen gas 1 condensed limiting the amount vented out of the system during flight. Also shown is the pipe from the cryotank truck 81 pouring liquid Nitrogen into the filling pipe 30 with irregular ends insuring the pipe on either end will release liquid Nitrogen even if pushed against the inner skin 33. This conserves liquid Nitrogen 10 in flight and during disbursement not releasing liquid Nitrogen outside except through the perforated unit 17.

FIG. 16b shows the remote control device 57 which is either or both in the cockpit of the helicopter and in the hands of ground based people supervising the flight.

FIG. 16c isolates the filling tube 30 and cap 82 which is in place during flight preventing the pipe contained liquid Nitrogen release during disbursement in flight. The cap placement is beside the perforated plate 17 where the filling tube 81 is shown, screwing into that area. The openings into the filling pipe 30 will extend beyond the cap to allow emptying of the pipe while inverted so all the liquid Nitrogen contained in the bucket can be disbursed through the perforated plate.

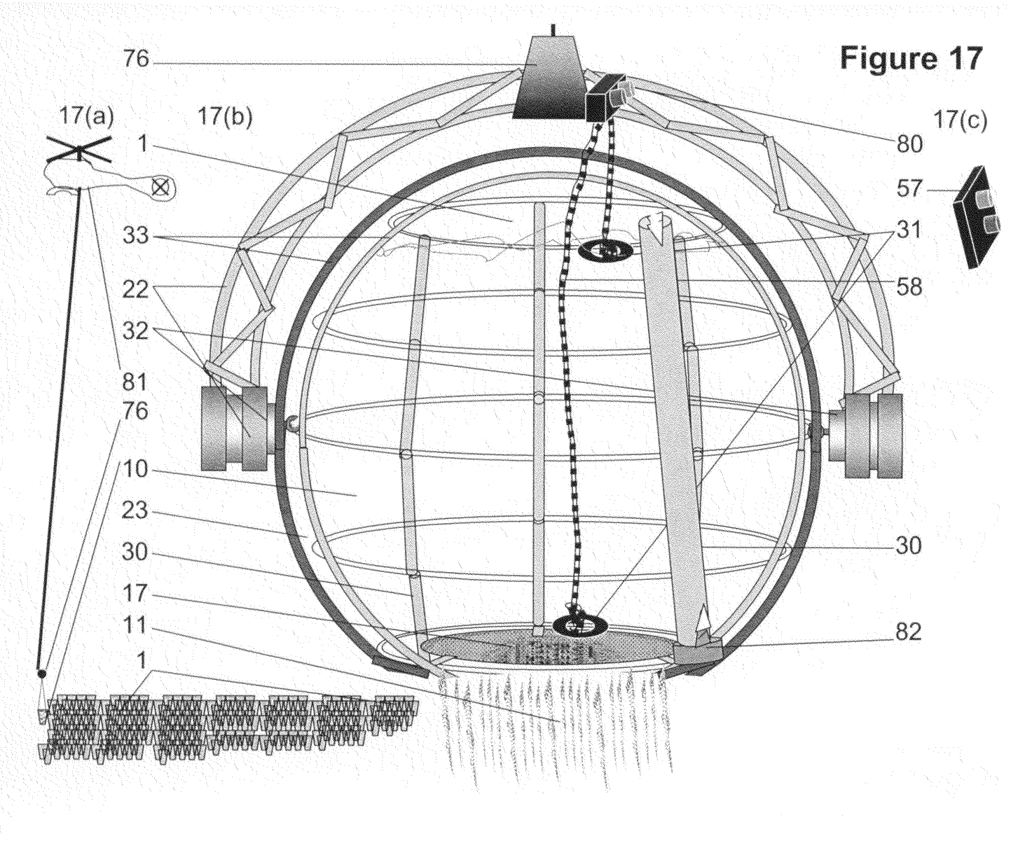

FIG. 17a shows the helicopter 81 with the stayline to the lift with scale 76 holding the bucket of liquid Nitrogen 10, with, as shown, the 230 bucket sized Nitrogen gas 1, the fire suppressant, volume provided to the crisis in that single drop.

FIG. 17b has the bucket inverted disbursing cryorain 11 through the perforated plate 17 which, as it drops, evaporates into the Nitrogen gas 1 cloud which is the agent of change in the crises. Note the cap 82 in place in the filling tube 30. To prevent icing in the air, the tube induced spacing 23 insulates the cryogenic contents of the bucket. The seamed material 33 of the inner and outer skins are sealed onto the perforated plate 17. The chain 58 with connectors 31 has pulled the bucket bottom up as the motor 80 activated by the remote control device 57, appearing in FIG. 17c, since it is at another location as before stated. The helicopter 81 attached lift with scale 76 holds the rack 22 fitting the roller bearing casings 32 holding the bucket and allowing its smooth rotation from carry to release positions. This tool applies Nitrogen gas 1 to control of major fires including wildland fires and should cut down the burn and speed of spreading rapidly. The fire draft in these circumstances moves so rapidly that any life in its pathway will only experience emersion for part of a second enabling no more than two breaths to be taken. This will have no adverse effect on the being since it provides, at most, a quick chill and a very minor reduction in Oxygen content of the lungs but for but a moment as the following breaths carry the ambient temperature air with full Oxygen content which comes from the fresh air region of the fire area.

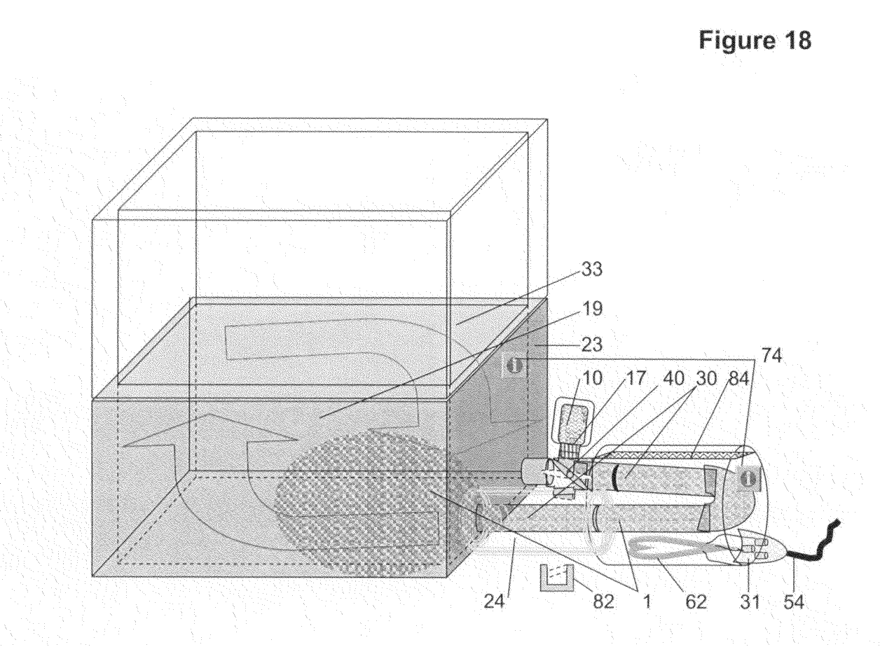

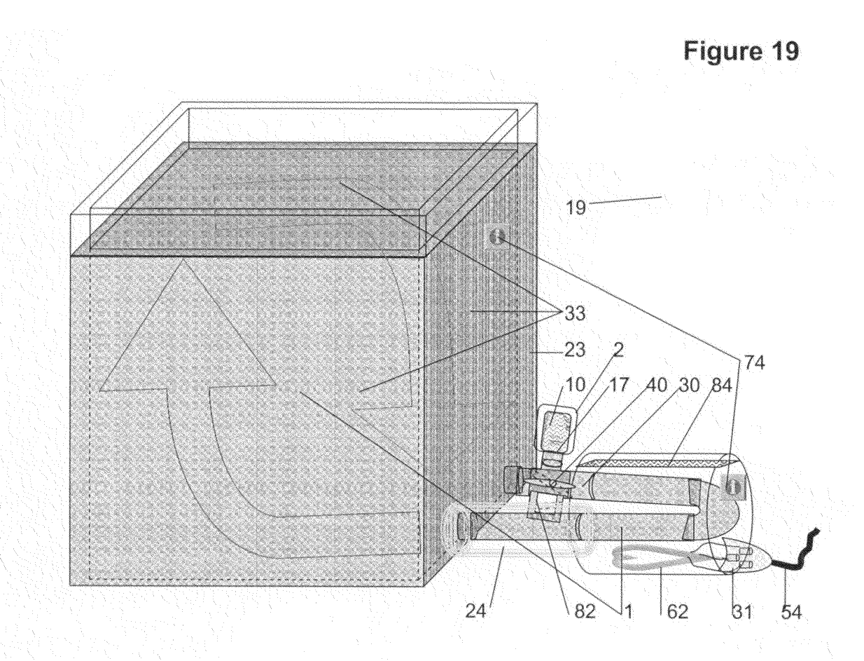

The fourth embodiment of this invention is included in FIGS. 18-19.

FIG. 18 shows a treatment container covered in seamed material 33 with frame induced spacing 23 here containing ambient air 19. It is being fed Nitrogen gas 1 from liquid Nitrogen 10 entering through a perforated section 17 and directed by a flow direction valve 40 to be warmed in the water bath 84 to the desired temperature using a heating element 62 with connector 31 and wiring to the electric outlet. Pipe 30 emerging from the output of the heating tank is insulated with insulating material 24 as a fleece wrap to retain the temperature desired. Thermal indicators 74 on both the water bath and the treatment containment all computer control of the operation programmed as needed and recording progress in thermal compliance. In this configuration to rid the treatment containment of ambient air 19, the Nitrogen gas 1 from the liquid Nitrogen 10 input forces the ambient air out of the system as the valve 40 deflects the air to escape through the open pipe from which cap 82 has been removed.

FIG. 19 shows the treatment containment 33 operating at the preferred temperature filled with Nitrogen gas 1. Note the valve 40 now allows recycling passage of Nitrogen gas 1 from the containment and through the water bath 84 heating unit 62 to maintain a given temperature over the time necessary to have the treatment effective. Also the cap 82, now in place on the pipe system 30 prevents loss of the Nitrogen gas 1 during the treatment and keeps ambient air 19 outside the system. The thermal indicators 74 allow control and recording of treatment thermal history where, for bedbug control the temperature of 180° F. or higher must be maintained for several hours to guarantee killing the insects and their eggs and immature stages. Using Nitrogen gas in this high heat treatment will prevent oxidizing materials in the environment during the process and prevent ignition which would destroy materials completely as well as whatever also ignited in the fire. With Nitrogen gas, burning cannot take place. Only evaporation of material components that evaporate at or above the temperature used.

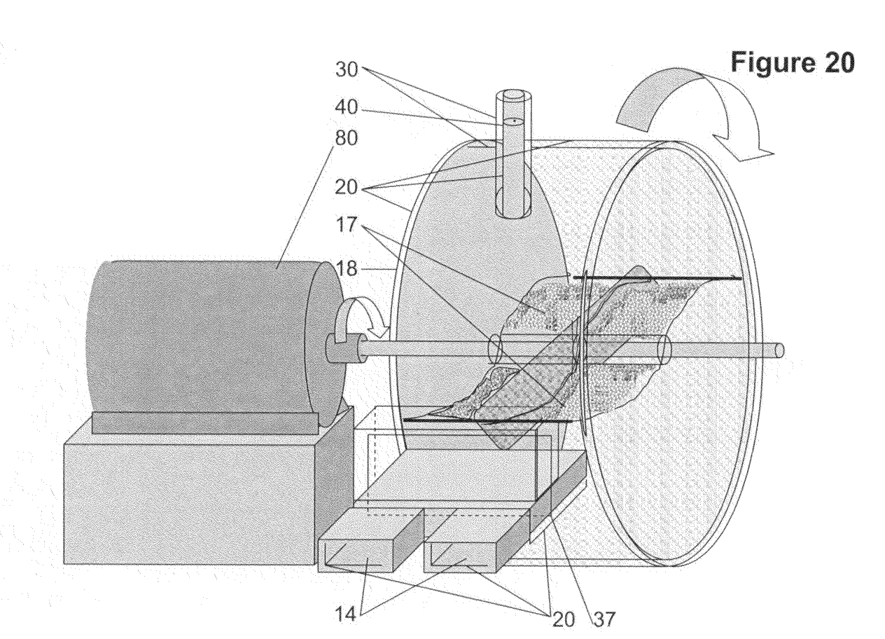

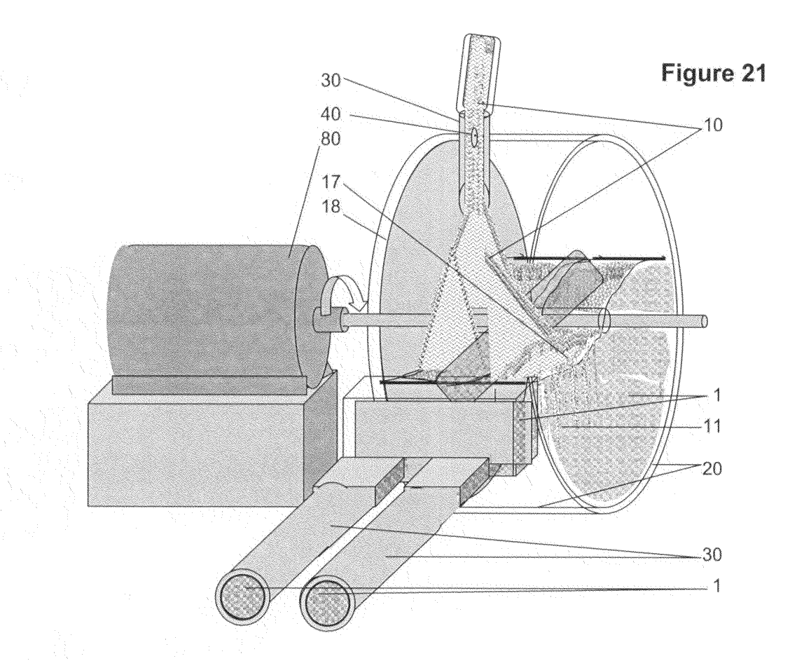

The fifth embodiment of the invention, presents the evaporator in FIGS. 20-21.

FIG. 20 shows the evaporator 18 with the cycling perforated section 17 driven by motor 80 and with filling pipe 30 for liquid Nitrogen entry and one way valve 40 here preserving the Nitrogen gas 1 in the cylinder made from a wide pipe with insulating space 20 preserving the cold. In the box shaped Nitrogen gas outlet, fused seamed baffle 37 prevents splashing liquid Nitrogen from passing into the cooling Nitrogen gas pipes 14. Arrows indicate the rotation direction of the perforated unit 17 in the stationary evaporator cylinder 18.

FIG. 21 illustrates the evaporator 18 in action outputting two streams of cryogenically cold Nitrogen gas 14 which feed cooling tubes to freeze pipes for sandbagging strengthening, for icing piping to create blocks and room for repairmen for dam and dike breaches, for freezing the cores of levees to increase their capabilities to handle water pressures and wind in severe and extreme categories (#4 and #5) of hurricanes and even to cool piping to stay lava flows in volcanoes. And it feeds the fuel extracting, remediating, flare abatement, and nuclear fuel reactor separation equipment. It belts forth a cold breath of pure, inert Nitrogen gas which stays in a cloud unless cutting winds of over five miles per hour mix it into the atmospheric air. Activating the flow is valve 40 open so liquid Nitrogen 10 enters the cylinder 18 and being driven by motor 80, the axle turns the perforated unit 17 inside the cylinder causing cryorain 11 below the cycling unit 17 evaporating into cryogenically cold Nitrogen gas 1, which flows through the outlet and over the liquid Nitrogen barrier 37 fused to the passage base and out the pair of pipes 30 with insulating spacing 20 to the piping or other situation.

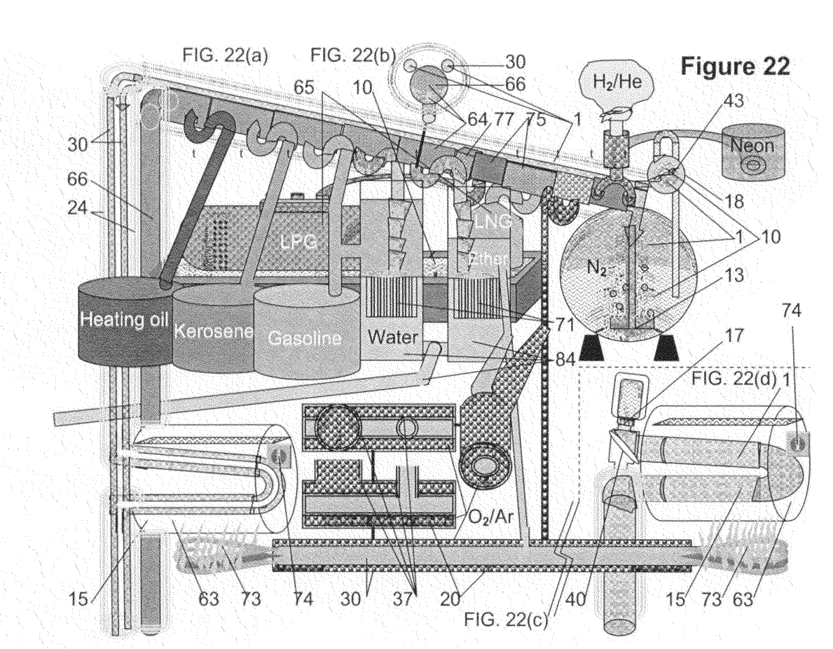

The sixth embodiment of the invention, the ground level section of fuel extraction equipment, is shown in FIG. 22a through 22d.

FIG. 22a presents the extraction equipment as would be, in the version shown here, used in situations to extract fuel from oil shale, peat and coal and landfill seams. The fossil fuels are labeled in white writing and the other materials separated in black letters. The process starts with liquid Nitrogen 10 entering the evaporator 18 with the cycling perforated paddle 17 evaporating the Nitrogen to gas 1 which then passes through two pipes 30 with thermal flow control 75 and wrapped with insulating material 24 with the parallel larger pipe 66 which contains the Nitrogen fuel mixture emerging from the ground and reducing in fuel and other material content as it cools. The two Nitrogen gas pipes 30 pass through the heating unit 63 being heated here to 375° C. which will evaporate the heating oil and all lighter fuels in the fuel source below the ground. This Nitrogen heating unit 15 is filled with motor oil 63 which evaporates at yet higher temperature and the heating is regulated 74 by thermal indicator and controls it drives with the fire 73 here fed with ether fuel and the Oxygen and Argon condensed in the fuel separation process to produce a very hot burn and to use the hard to market ether fuel segment. The Oxygen/Argon mix not heating the flames here can be condensed, contained and used to fill Oxygen compressed gas tanks for use on the site or sold to industrial gas companies.

Emerging from the ground in pipe 66 is the Nitrogen gas mixed with fuels and materials which is packaged with the insulating material 24 with the Nitrogen gas pipes 30. It proceeds into the separation section regulated by the thermal flow control 75 condensing first heating oil, then kerosene used for diesel oil and jet fuel, and heavier gasoline which is then combined with the lighter gasoline that needs to be separated from the water 84 in the extraction in the separator unit 71 as is the next ether gas section. Next comes the Carbon dioxide filter 77 using Calcium metal as the catcher shown here or a rotating cylinder of pipe segments where CO₂ accumulates as dry ice in the condensing sequence, and, as the pipe segment fills, the rotation inserts a fresh pipe segment allowing the dry ice to be removed from the just released segment and a third pipe segment on the rotation cools down to temperature to be inserted when the current pipe section is sufficiently filled with dry ice. Further cooling liquefies the LPG, Butane through Ethane gases, and then Methane gas as the LNG output both of which are condensed in a liquid Nitrogen bath. Oxygen and Argon are removed next together, leaving the coolest four, Hydrogen, Helium, Neon and Nitrogen. Nitrogen gas 1 is released in the liquid Nitrogen 10 storage tank where much of it may liquefy 13 sustaining that supply. The remaining gases, Hydrogen and Helium are very light and Neon heavier so the top section is separated from the Neon. As the Calcium metal clogs. with Carbon dioxide, it can be reduced to the metal again with the captured Hydrogen gas releasing Carbon dioxide and water. Both these can be frozen out leaving the Helium gas to be held in a canister and sold. The dry ice chunks can cool down refrigerator units on location—a step toward Green living.

FIG. 22b shows a cross section of the fuel and Nitrogen pipe 66 and the Nitrogen gas cooling pipes 30 with, here, ether and water liquefied cooling to separate 64.

FIG. 22c further illustrates the ether/water separation in the separator 71 insuring little disturbance in the separation process leaving liquids water 84 in the lower section and ethers on top since ethers have lighter mass than water. For convenience here, the ethers are piped in the inner pipe of pipe pair 30 and the Oxygen and Argon mix is moved through the space between the pipes 20. This double pipe feeds the burners 73 used to heat to selected fuel temperatures 63, here at 375° C. for oil shale and landfill seam fuel extraction. Handling this explosive mix in one unit, all seams are fused 37 to prevent their mixing until the burners are fed with both substances mixed. Again, the thermal indicators 74 regulate the burn heat levels and timing.

FIG. 22d shows the auxiliary cooling and then heating process unit. On expanding the extraction zone, the area of freezing of the ground must be expanded so drillings in a matrix of, say for now, 25′ separation, freezes the ground with the liquid Nitrogen 10 as illustrated in FIG. 10 or with this configuration leaving the heating unit without water and well insulated so the cryogenically cold Nitrogen gas floods the ground. Expanding the zone further, the next set of drillings away from the central drilling is flooded with the freezing apparatus and the closer one is then heated to the extraction temperature of the selected fuel 15. This double pipe feeds the burners 73 used to heat to selected fuel temperatures 63, here 375° C., using motor oil in the heater for oil shale and landfill seam fuel extraction. Valve 40 which directs the flow from the Nitrogen source allows venting the system as needed. And the temperature indicator 74 allows these remote places to be included in the thermal programming of the entire area of fuel extraction, remediation, flare abatement, nuclear primary reactor cooling and other applications.

The seventh embodiment of the patent shows a room on fire in a building with fixed Nitrogen fire control.

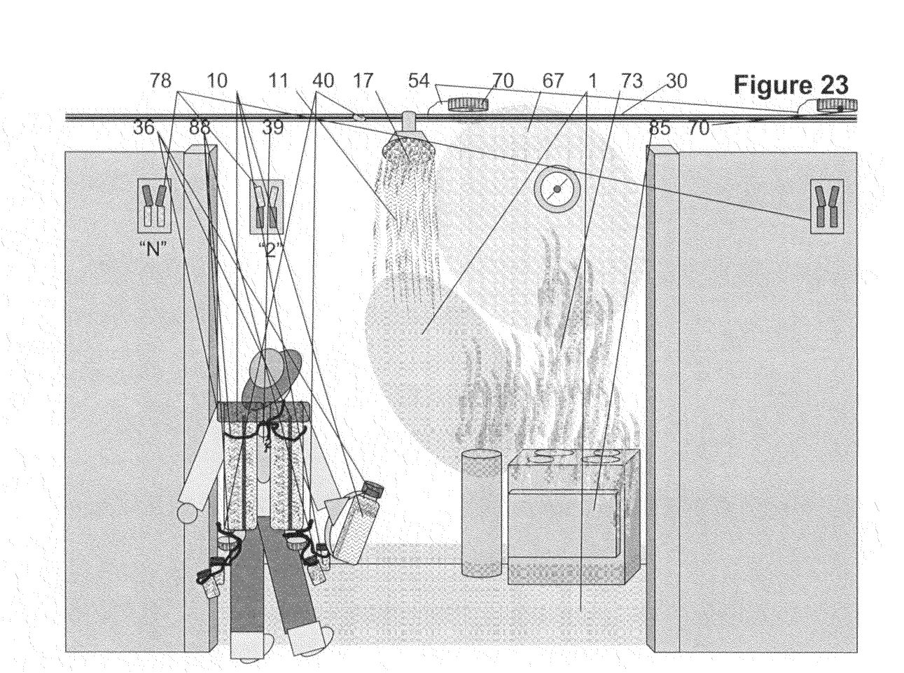

FIG. 23 shows a kitchen fire in a building with fixed Nitrogen fire control where pipes 30 carry liquid Nitrogen to where the smoke detector 70 wired to the Nitrogen control system for the building causing the valves 40 to position the flow of liquid Nitrogen from the storage tank to the fire location where the valve 40 shown here stops flow beyond this point. The perforated outlet 17 drops the cryorain 11 evaporating into the pure, inert, cryogenically cold Nitrogen gas cloud 1 forms and falls either being pulled into the fire or onto the floor where it accumulates allowing clear view through the inert gas. The fire 73 is from the oven 85 with flames giving off smoke 67. The Nitrogen signals 78, when activated show in finger spelling the letter “N” followed by that for number “2” and the audio signal says “N 2 N 2 N 2 N 2” warning of Nitrogen. The Nitrogen signal on the far right where there is no fire is not activated so it sits dark and quiet. A first responder arrived carrying Nitrogen in containments illustrated in the second embodiment of this patent, FIGS. 9-13 including the large inverted dewars on his or her back with an Oxygen provider 39 to be used as needed, the Nitrogen Fire Extinguisher in hand and the peanut butter jars with perforated caps tethered hanging from the waist. Note the bare hands, the safest way found to handle these cryogenics because with gloved hands the gloves accumulate the cold in the humid inner air because hands sweat making freezing the fingers more possible. Also, insulating fleece and the like only insulates when there is no pressure on the fluffy material. Pressing on an area where the fleece is insulating it will result in frost bites on the fingers. With bare hands, one can feel the change in temperature and recoil so as not to get cold induced injuries. Bare hands also allow one to do the post fire analysis feeling for hot spots in the environment.

FIG. 24a shows the fire situations a few moments later with the Nitrogen gas 1 from the Fixed Nitrogen Fire Control System 30 nearly ending the fire 73 in the oven 85, the smoke cloud 67 has risen still activating the smoke alarm 70 and the Nitrogen gas clouds 1 have centered on the fire location and with the burn nearly over is now dropping to the floor rather than being diverted into the fire since it has lost its strength to pull in fresh air in quantity. The first responder's load of liquid Nitrogen 10 has them held with ties 88 and the Nitrogen fire extinguisher with the ventilated cap 36 in one hand with the perforated pan 17 also attached to the dewar with a tie 88. Also, between the dewars on his or her back is the Oxygen device 39 ready for use as needed.

How much liquid Nitrogen 10 can the first responder carry? Here illustrated are two three gallon tanks vented through the filling tube held as a back pack, the four liter or one gallon Nitrogen fire extinguisher with the ventilating cap 36, and four pint sized peanut butter jars with liner holding 0.8 pints each ventilated through the perforated cap 17 which holds the tie 88 in place which is hitched to the first responder's belt. Without the fixed Nitrogen fire control system, what is carried would be sufficient to end the fire. Here is a chart showing the volume, the weight of the Nitrogen and the containments and the volume of the Nitrogen gas at cryogenic temperature resulting from evaporation of the cryorain passing from these carriers. The perforated exit for the largest dewars is the rain makers 17 at the base of the dewars with the valve control 40 shown to the outside of the top of the insert to the bottom of the dewars.

CHART OF NITROGEN CARRIED TO CRISIS BY ONE PERSON

| | | | | | Gas |
|---|---|---|---|---|---|
| | | liquid | Tare | | Volume |
| | Volume | Nitrogen | Weight | Mass | Cubic |
| | Gallons | Pounds | Pounds | Pounds | Feet |
| Large Dewars (2) | 6 | 38.4 | 6 | 44.4 | 184.5 |
| N₂ Fire Extinguisher | 1 | 6.4 | 2 | 8.4 | 30.75 |
| Peanut Butter Jars (4) | 0.4 | 2.6 | 1 | 3.6 | 12.3 |
| TOTAL | 7.4 | 47.4 | 9 | 56.4 | 227.55 |
| | | | | | or 1,702 |
| | | | | | gallons |

The above data shows that carrying liquid Nitrogen gives 230 times the volume of fire suppressant, here Nitrogen gas, than the amount of liquid available. Pure Nitrogen as a liquid expels contaminants as does the Nitrogen gas cloud retaining its ability to displace Oxygen and carry the coldness. As Nitrogen gas warms, it expands further to 250 times liquid volume at ambient temperature and over 600 times liquid volume at inferno temperatures as is frequently experienced in fires. This makes liquid Nitrogen 10 the ideal conveyor of fire suppressant, the expanded Nitrogen gas 1 on evaporation.

FIG. 24b illustrates the ventilated cap 36 for dewars 30 that are carried bottom end up where there is a hole with sealed insulating space 20 in the bottom with an extended moving insert which when upright for filling lays against the inside bottom sealing the hole, but when inverted the weight of the insert pulls it down leaving gas passage from the dewar into the rain protecting cover 89. This cover serves as the base during filling. Without this bottom placed ventilated cap the liquid Nitrogen 10 would be forced out the perforated outlet 17 wasting the supply of liquid Nitrogen before getting to the use point or place where it should be disbursed. And without it in the inverted position, the pressure would build in the dewar either causing the liquid Nitrogen 10 to squirt out the perforated unit 17 forcing past the valve 40 or rupture the dewar to escape when the pressure exceeds the strength of the dewar unit.

Here inclusion of the unpublished reference, Nitrogen Article, by inventor Denyse DuBrucq is included describing her observations of Nitrogen over the years.

Many changes and modifications could be made to the invention without departing from the spirit thereof. The scope of some of these changes can be appreciated by comparing the various embodiments as described above. The scope of the remaining changes will become apparent from the appended claims.

### APPENDIX A—NITROGEN ARTICLE

### If there is Life on a Planet it has a Nitrogen Atmosphere—Bet'cha

Everyone is tooting “water, Oxygen, Carbon” in searching for life here and there in the Universe, but the real deal is “Is there a Nitrogen atmosphere?”

Yes, Nitrogen is an inert, diatomic molecule that freezes at the fourth coldest temperature of materials on earth—following Helium, Hydrogen and Neon. The Noble gases, Helium and Neon, in the list give the inertness of the Nitrogen molecule a flavor of nobleness. Reactive Hydrogen is there because it is a proton and electron atom which is stuck together with another Hydrogen atom making the lightest weight molecule possible, H₂.

It is not the freezing temperature we are citing for the reason why life needs Nitrogen. It is its valence which holds the two Nitrogen atoms in the molecule, N₂. The reason non-homogeneous material Nitrogen molecules often are explosive is that Nitrogen fits better with itself than mixed with Oxygen, Carbon, Hydrogen and the like so it explodes to rid the atom of unlike material to couple with another Nitrogen atom. But when you've got the diatom of Nitrogen only, it becomes near inert being split by lightning or bacteria, mostly the rhizome root nodule bacteria of legumes, but a few species of bacteria can go it alone, which Germans used during World War II to increase the supply of explosives.

What holds Oxygen, Carbon dioxide, Hydrogen, water and other gases to the moon? Not a lot. But put a cape of Nitrogen gas around a planet or satellite and it will embrace the sphere because the Nitrogen molecule has affinity for itself. Liquid Nitrogen carries impurities outside of the glob of pure liquid. The same occurs with Nitrogen gas though it cannot be seen. Yes, the other materials mix in with cutting winds of over five miles an hour, but with a 78% Nitrogen atmosphere here on earth there is that intermolecular pull which keeps the gaseous components of the atmosphere as a unit, a blanket for the earth. Titan, Jupiter's moon, has a Nitrogen atmosphere. Any life there? It is the closest, best candidate for extra-terrestrial life currently known.

Valence is a major factor defining the characteristic of Nitrogen (N₂). Hydrogen (H₂) along with other seven of eight electron outer shells as Fluorine (F₂), Chlorine (Cl₂), Bromine (Br₂) and Iodine (I₂) and often Hydrogen combines with any of the other in the same electron deficient pairing making water soluble acids. These are totally reactive diatomic molecules. Oxygen with two electrons out of the outer shell combines into a more stable molecule, (O₂). When combined with Hydrogen, H₂, it explodes into water and oxidizes metals, especially in high humidity. Most life breathe Oxygen.

Nitrogen atoms are missing three electrons in the outer shell and combine with another Nitrogen atom. There must be considerable inter-molecular sharing of electrons among these like molecules causing an expulsion of other types of atoms and molecules. The N₂ molecule braids a network of like molecules excluding as best it can other atoms and molecules. When there is too much water vapor in the air, it coalesces and rains. Oxygen is kept at twenty one percent (21%) a tolerable level for plants and animals. It will hold particulates and charged molecules from FeO types to carbon chains as well as contain particles for long periods placing them elsewhere on earth.

When Mt. St. Helen's volcano blew in Washington State, USA, dark red pumas fell from the sky in Boulder Colo. disturbing the wax job I had just given my car that morning, a day after the eruption. I also encountered wildfire smoke from Steam Boat Springs, Colo. 125 miles away and 5,000 above I-76 30 miles north of Denver stopping traffic.

So, rocket scientists, if you want to find a life tolerant planet or satellite, look to the Nitrogen atmosphere and the Oxygen level will be hospitable, water will be tolerated to a given concentration and then it will rain putting water on the surface. Particulates will be carried around the solid sphere for a period of time and then dropped to the ground. Does this all happen on Titan, the Nitrogen atmosphere contained satellite of Jupiter?

Making my case further for valence attraction, the Carbon atom makes chains, but in its extreme form is pressured into a C₄ solid we refer to as diamond and the longer the pressure the fewer contaminants with the purest carbon solids being clear diamonds. Going from amorphous coal to bituminous and anthracite coal, slate and then diamond, the carbon preference is bonding with itself in solid state like what is described here for the attraction for Nitrogen molecules for itself in both the gaseous and liquid states Nitrogen exhibits inter-N₂ molecule attraction.

Granted it is hard to study a pure, inert substance, liquid or gaseous, but observing the pattern of clear air surrounded by water vapor as its cryogenic temperature dissipates, one can see gathering of the clear air that eliminates the burn when a burning match is dropped in with the cloud of water vapor above the clear air which is a Nitrogen gas cloud. In another experiment, observation shows the cyrogenic temperature (−195.8° C.) carries to the evaporated Nitrogen gas which solidifies oils on water which, to a limited extent, also freezes making chunks of ice. Solids can be collected with a skimmer or net and placed in a container to melt. Oil floats on the water making separation an easy task. A Nitrogen cloud which is cohesive to itself, displaces Oxygen ending fires.

The recorded expansion of the liquid Nitrogen when evaporating is 230 times volume of the liquid as the cryogenic gas, 250 times volume as a room temperature gas and, encountering infernos, at 600° C. or so, 600 times volume. This displaces the Oxygen so a cloud of Liquid Nitrogen rained into a fire draft is pulled along the ground as a cold cloud into the fire at the base of the trees and bushes cooling the fuels and displacing Oxygen stopping the burn and, heated rises in the fire column ending the fires as it rises expanding in inferno temperatures in the heat of the burn to over 600 times volume displacing Oxygen in treetops still ending the fire there including that of the burning embers which, blown into the area of fresh air which spreads the fire, prevents this means of spreading the fire. This fire fighting tool works all the way bottom to top, not dissipating but continuing to prefer like molecules. Puddled water does not fight fires.

Rapid evaporation occurs when the Liquid Nitrogen is dispersed through holes—a spaced hole sieve—making it rain. The small drops warm evaporating the Nitrogen because there is not enough mass of Nitrogen to perpetuate the liquid phase. As these spaced drops evaporate, they push out other atoms and molecules forming the pure, inert gas cloud of Nitrogen. We on earth can protect the earth from fires, flooding, tornados, toxin releases and spills using this material as described in U.S. Pat. No. 7,631,506 of this author. With now 13.8 years more of exclusive rights assigned to CryoRain, Inc., do contact us and we will end all kinds of fires with no water damage and no electrical arcing making recovery only replacing what burned away, charred, warped, melted or scorched. Yes, it still smells like a fire, but with repair as listed and treatment with Febreze® or like material, one can be back operating in the fire location in a very short time with little to replace and no loss of electronics, memorabilia, equipment, décor and possessions unless it was part of the fire.

Using Nitrogen underground can end coal mine fires and other embedded fires, can extract pollutants by Nitrogen remediation in-situ, and can extract all fuels from oil shale and landfill seams carrying them to the surface in Nitrogen gas. And, in the process of cooling the Nitrogen mix, it separates the fuel types as the Nitrogen carried carbon compounds from the ground by condensing them as the mix cools as the mix approaches the Liquid Nitrogen tank share thermally the lowering temperature levels until the Nitrogen gas liquefies to some extend leaving only Neon, Helium and Hydrogen gases.

Dispensing Liquid Nitrogen in flight, we can flood the top section of the wind vortex of tornadoes in the edge curl of clouds producing tornadoes with cryogenic Nitrogen raising the air pressure and lowering the temperature which dissipates the wind generating capability spoiling the funnel wind pattern and thus preventing the tornado that might have ripped up the features of the earth's surface below.

Also, with lightning starting wild land fires beyond civilization, airdrops of Nitrogen into the fire draft quell these fires before they get powerful and cover a large area. This prevents loss including the need for fighting the huge blazes with losses and cost of recovery from the massive, weeks long burn. The Rim Fire in California, Aug. 17-Sep. 29, 2013 consumed over 402 square miles and, at 84% containment September 26, needed 2,170 first responders at its peak with 733 personnel working September 26, which threatened 1,285 structures though the given count includes 11 homes, 3 commercial sites and 98 outbuildings destroyed, with only 10 injuries, at a cost of $125.25 million to date to fight. Even prisoners participated but CryoRain Inc.'s Nitrogen technology was banned from use by the US Forest Service.

After learning of a grant request made by CryoRain to the Department of Defense Legacy effort to fly liquid Nitrogen filled cryotank trucks in C-17s to abate tornados and control wildland fires, Shirley Zylstra, heading the Chemical Section of the Missoula Montana's Technology Development Center run by US Forest Service, stated that were the money awarded and the effort underway, they will restrict tornado abatement and wildfire control to Department of Defense lands only. In essence here the Department of Defense is being prevented from protecting this nation against tornado damage and wildland fire damage by the United States Forest Service personnel.

Professors from distinguished universities state that this science is too basic to even be a science. They refuse to see demonstrations. Their power is in the thermal change and the means to prevent chemical reaction is with the inert, pure Nitrogen gas just evaporated from liquid Nitrogen. Yes, it is simple. Were it applied to cool the Fukushima fuel rods in the Dai-ichi Plant in Japan so no melt down would have occurred. They used water and stand with 110 tons of water with radioactive contamination. With Liquid Nitrogen we could freeze this contaminated water into ice blocks for transport and disposal. And the current refrigerated ground freezing could well be accomplished using Nitrogen gas from liquid Nitrogen to prevent the stored contaminated waters from reaching the ocean. What became obvious after these proposals were not accepted was that Nitrogen can replace water as the coolant of primary reactor sections of nuclear plants, eliminating both the hot waters around these plants making them easy to locate in an attack and eliminating the cause of meltdowns, super heated water reacting with Zirconium fuel rods. These new Nitrogen cooled reactors can be placed anywhere including powering trains and ships. What is really nice is that the Nitrogen can be cycled back into Liquid Nitrogen and in the process separate radioactive material from the fuel rod decay recovered as specific chemicals at reagent quality.

The question now before us is, if this range from preserving life on earth with reactive gases kept at livable levels to ending many natural, accidental and man induced crises, and substituting for water to cool materials, where else will it be found to be helpful? Is this non-science really too basic to consider? Or should people consider its uses to save the planet? Global cooling might be implemented by ending coal mine and other embedded fires; rapidly controlling wild land fires and other major fires; capturing and selling the light fuels rather than flaring them; and abating smoke from fossil fuel burning plants. These four tasks applied worldwide, the sea levels could begin lowering because the earth is not being directly heated by coal mine and other embedded fires and the air is not being heated allowing the water from the air to again build up the polar ice and glaciers rather than increasingly fill the oceans. And the air is no longer increasingly contaminated by smoke from fires, flaring and burning fossil fuels.

Let's put it this way. This discovery deserves testing by the United States agencies including: for wildfire control by the US Forest Service, mining and remediation by the US Department of Energy, the fire and crises by the Department of Homeland Security, the flood prevention by the US Army Corps of Engineers, the prevention of chemical reaction by the Navy Explosive Ordnance Division, the quick control of petroleum fires and non-arcing of electrical fires by the Department of Transportation for controlling accidents of fuel and electric vehicles, and the non-lethal weapon aspects by the Joint Non-Lethal Weapons Directorate of the Departments of Justice and Defense. And, because this is a new science, patent issued, U.S. Pat. No. 7,631,506, the National Science Foundation could fund exploration into this as well. The US Nuclear Regulatory Agency should also review the Nuclear aspects in that both the fixed fire and crises control with Liquid Nitrogen to protect existing Nuclear power plants and the substituting of Nitrogen for water as a reactor coolant could change the character of the Nuclear industry. It would make it safer and prevent waterborne radioactive contamination of the planet. It should be implemented in the Great Lakes watershed which has an extremely slow flush and contains 90% of North America's fresh water supply. And the Environmental Protection Agency where Nitrogen used in handling crises and fires does not pollute in any manner, the methods should be preferred to chemical means. Remediation with Nitrogen will pull even the dioxins now admitted to be in the ground around Dow Chemical Company, but can flow into the streams and then into the Great Lakes. And with less smoke in the air because fires are less destructive, the Health and Human Services group will find cases of Chronic Obstructive Pulmonary Disease, COPD, will be reduced and aggravation diminished world wide. That is the only major killer disease not currently being conquered.
Something to think about and act on,
Denyse DuBrucq EdD
CEO—CryoRain Inc.

Numbering Index
1. Nitrogen gas

| | |
|---|---|
| 10 | Liquid Nitrogen |
| 11 | CryoRain - drops |
| 12 | Stored N₂ to fill pipes |
| 13 | Liquefying N₂ |
| 14 | Cooling N₂ |
| 15 | Heating N₂ to gather fuels |
| 16 | Purifying N₂ |
| 17 | Perforated surfaces |
| 18 | Evaporator |
| 19 | Air - atmosphere |

2. Insulating spaces

| | |
|---|---|
| 20 | Parallel pipe space |
| 21 | Molded components |
| 22 | Fitting other products |
| 23 | Frame induced spacing |
| 24 | Insulating material |

3. Plastic

| | |
|---|---|
| 30 | Pipes |
| 31 | Connectors |
| 32 | Roller bearings |
| 33 | Seamed materials |
| 34 | High temperature |
| 35 | Installed components |
| 36 | Ventilated cap |
| 37 | Fused seams |
| 38 | Slow flow pipe |
| 39 | Oxygen supply and tube |

4. Valves, motion

| | |
|---|---|
| 40 | Allow/stop flow |
| 41 | One way valve |
| 42 | Tippers - fill & spill |
| 43 | Cycling - evaporator |

5. Electronics

| | |
|---|---|
| 50 | Lighting |
| 51 | Batteries - solar |
| 52 | Situation switching |
| 53 | Valve motion |
| 54 | Wiring |
| 55 | Indicators |
| 56 | Regulators |
| 57 | Remote control |
| 58 | Chain puller |

6. Thermal qualities

| | |
|---|---|
| 60 | Switch by cold |
| 61 | No frost or icing |
| 62 | Heat to kill bedbugs |
| 63 | Heat to select fuel |
| 64 | Cool to separate |
| 65 | Cool to liquefy |
| 66 | Keep hot for fuels |
| 67 | Smoke |

7. Signals

| | |
|---|---|
| 70 | Smoke detector |
| 71 | Fuel/water separator |
| 72 | Battery operating |
| 73 | Fire |
| 74 | Thermal indicator |
| 75 | Thermal flow control |
| 76 | Lift with scale |
| 77 | C0₂ filter |
| 78 | Nitrogen release signal |

8. Item

| | |
|---|---|
| 80 | Motor |
| 81 | Truck |
| 82 | Cap |
| 83 | Oil spill |
| 84 | Water |
| 85 | Oven |
| 86 | Clothing |
| 87 | Skimmer, net |
| 88 | Ties holding equipment |
| 89 | Cover to protect from rain |

1. A method of safely containing and transporting cryogenic substances as liquid Nitrogen to disbursal locations such that:
a. the carrying of the cryogen is without spill or splashing;
b. dispensing means for the liquid Nitrogen is part of the transport vessel or pipe provides a perforated outlet to the transporting unit, wherein the applying unit is a generally either a pan, trough or elongated structure and comprises a plurality of apertures so liquid Nitrogen flows unimpeded from the carrier into and through the applying unit;
c. the mass, weight, of the transport unit is comparatively low allowing carrying more of the cryogen at the same maximum poundage; and,
d. the cost of the transport unit is low allowing for very infrequent use, as with Nitrogen fixed fire control piping, or abandoning the unit, as a portable unit, in fire fighting or other first responder tasks as needed.

2. The method according to claim 1, wherein the cryogen transport units are conveyed by overland vehicle, truck, boat or aircraft to the use-point and disbursed from there to the target locations for cooling and/or fire control or energy situations.

3. The method according to claim 1, wherein the system is fed from a stationary tank mounted higher than the disbursing system with the perforated pan or trough placing the liquid Nitrogen where needed to fall evaporating into a pure Nitrogen gas cloud and to preserve the integrity of the system, vertical pipes drop from the system to hold enough liquid Nitrogen during disbursal to retain Nitrogen gas atmosphere in the inner pipes.

4. The method according to claim 3, wherein the liquid Nitrogen is transported to the smoke detector alarm location in a fire by means of short-term transporting tubes or pipes mounted for gravitational flow of liquid Nitrogen through valves opened or closed to convey the liquid Nitrogen to the disbursing perforated unit at the location of the smoke alarm signal with cornering using 45 degree bends so smooth flow of liquid Nitrogen is uninterrupted and the pipe system insulated by air spaces between pipes to retain a comfortable to touch outer temperature.

5. The method according to claim 3, wherein programming of Nitrogen gas disbursed from the perforated units releases a portion of liquid Nitrogen to evaporate to partially fill a space limiting the fire as the Nitrogen signal lights and sounds get those present to leave the area and allow for officials to inspect the space, after which, when all are out of the space and doors closed, additional liquid Nitrogen flows to flood the space controlling the fire with Nitrogen gas, ends the fire with no water damage or electrical arcing.

6. The method according to claim 5, wherein the initial splash of Nitrogen gas on the fire or into the fire draft in a building fire environment before victims and pets are sought lowers the Oxygen consumption by the fire leaving more for the breathing of victims and pets during the rescue as well as preventing the low-Oxygen deadly agents released in the fire like Carbon monoxide and cyanide which can rapidly kill those breathing these substances in the smoky, polluted air of a fire, thus saving lives of those being rescued.

7. The method according to claim 1, the liquid Nitrogen droplets are dispensed from a distance such that the droplets have substantially evaporated prior to reaching the surface to best locate the forming Nitrogen gas cloud to cool and/or deprive an event of Oxygen.

8. The method according to claim 7, wherein items cooled, once solid or gelled, can be transferred to a sealable container to safely move the material contained and dispose of the material, not contaminated by absorbing materials as sand or paper, appropriately.

9. The method according to claim 1, wherein the short-term transport products are made of plastic in units that are fuse sealed together, even sealing into double wall units wiring for the system, solar batteries illuminating light units for safety lights, such that units can be made of various sizes and complexity depending on need in specific environments, and unit numbers between end points, enabling locating equipment or as area night lights.

10. The method according to claim 9 wherein the sealing points between sections seal and keep separate the inner layer components from the outer layer components such that the dead air space is continuous throughout the unit as is the cryogenic transfer space.

11. The method according to claim 1, where needed, carrying means as installed handles, shoulder straps for back pack units or cord connectors for items dangling from the belt are properly attached and safe for carrying into dangerous situations, these means keeping disbursing sections of the device upward in the acts of transport and carrying.

12. A method according allowing the short term transport units to be designed specifically for various applications, as, for instance, underground spaced disbursements of liquid Nitrogen down a drilling to flood ground and freeze the earth, or light items with small apertures to shoot liquid Nitrogen a distance sidewise before falling and evaporating to get Nitrogen gas to areas inconvenient to reach that are on fire.

13. The method according to claim 12 of filling the cryogenic containers with Nitrogen using a filling tube that releases the liquid Nitrogen at the bottom of the container preserving more of the liquid Nitrogen having irregular ends, top and bottom of the tube, the flow from the filling tube is not blocked when placing the coldest liquid into the coldest space in the container, and, where that tube is retained in the container and the filler tube entry is capped, it empties within the container rather than outside.

14. The method according to claim 12 wherein the cryogenic transport unit is large as can be carried by a helicopter dangling from the craft and the containment and release is controlled remotely, is such instance as with one end upward the load is secure and with the other end upward, the cryogen is disbursed through a perforated plate creating cryorain which evaporates into the inert, pure Nitrogen gas cloud holding its integrity because the new air mass differs in temperature and content, and because, in the case of Nitrogen, the double Nitrogen atom molecule, N₂, resists contamination by other types of molecules, retaining its fire suppressant status throughout the warming process in a fire.

15. The method according to claim 12 where liquid Nitrogen is the means of transport in the volume provided, and, as passed through the perforated outlets, rains in droplets that evaporate into Nitrogen gas clouds, the fire suppressant and source of cooling, which is some 230 times the volume at cryogenic temperature, 250 times volume at ambient temperature and as it heats in infernos while ending fires, over 600 times volume at those extremely high temperature giving the use of this method one of the most efficient transport possible, comparing with water transport where the water, not steam or water vapor, is the fire suppressant where a pint in is a pint effective, Nitrogen is a pint in and 230 pints of cryogenically cold gas as the effective agent, and liquid Nitrogen being eight tenths (0.8) the mass of water, enables more liquid per pound ported.

16. A method of using a gaseous agent, rather than liquid which passes through the target situation and then puddles on the ground, which can be placed where the air is drawn by the fire in the fire draft and be drawn in the air movement into the fire at the base of the burn when at cryogenic temperature being a heavier gas keeping its integrity, and, as it suppresses the fire and cools the fuel, warms and becomes lighter weight, its volume growing larger, rises in the space of the fire ending the fire in new locations, and continuing, heating as it suppresses the fire to inferno temperature expanding and the suppressing the fire in the high, extremely hot zones, and, as with ever spreading wildland fires where the twigs and leaves in the canopy no longer are burning providing hot embers to the air stream from the fire spreading the fire, ends the progress of the fire and then dissipates into the air where Nitrogen is normally 78% of the air.

17. The method according to claim 16 where Nitrogen gas, with its affinity for Nitrogen expels other gases so that when placed in a fire environment will settle low, on the floor, and push out and upward smoke and steam and other perils to breathing and visibility, forms in a closed fire environment visible space on the floor aiding first responders to locate victims and pets more quickly so the area can be cleared and the full press fire control can commence, which when using Nitrogen will be drawn to the fire and end the burn without water damage or electrical arcing, and in spill recovery and heated to carry contaminating pollutants and fuels, leaves the recovered materials in full volume without absorbing sand, paper or other carrier, but pure to the point it can be used or sold to refineries and processors.

18. The method according to claim 17 where situations that could explode or be consumed or aggravated by rodents or insects can be washed in Nitrogen gas expelling accumulating Hydrogen, Carbon monoxide, Methane and the like to make the circumstances safe and, when storing commodities as food, prevent their consumption during storage and transport, and when the ground is flooded with Nitrogen gas hot enough to evaporate fuels, it carries these fumes to the surface and deposits the various types of its content according to temperature of its condensing as the mixture is cooled leaving these components pure enough to take to market or, depending on substance, the refinery or processor, and flooded with Nitrogen, the ground near Natural Gas leaks can be cleared of Oxygen so the situation does not explode when the metal digging tool hits rocks or metal and sparks an explosion.

19. The method according to claim 18 where Nitrogen gas, being a fire suppressant, can take chemicals which would normally burn or explode in the gas cloud at higher temperature than they would remain unchanged in the air and, when cooled, release those materials in the same chemical state they were evaporated in giving means of removing fuels, Hydrogen, Chlorine and other toxic gases, and condense or isolate them safely sometimes in pure form for later use, marketing or use in processing to eliminate toxicity.

20. The method according to claim 16 where transport of liquid Nitrogen when evaporated can be disbursed into conditions of low air pressure and/or high temperature and, as the gas cloud forms and expands, raises air pressure making pressure differentials that drive damaging winds dissipate as to, for instance, abating tornadoes, or to cool air temperature, even as it contacts the pipe of hot air cooling the pipe and contents by warming the pipe of cryogenically cold Nitrogen causing separation of materials contained in the pipe of hot gases, in fuel extraction, remediation, and toxin isolation, separating Nitrogen from other evaporated material mixtures and separating these materials one from another.

21. A method of treating flesh and clothing fires such that the Nitrogen gas ending the fire does not pollute the developing wound leaving the tissue clean of fire suppressant agents and with no tissue reaction to the inert, pure Nitrogen gas cloud with the coolness of the gas comforting to the fire victim speeding the tissue cooling which can reduce further potential damage.

22. The method according to claim 21 that enables solidifying, freezing and removal from tissue and clothing of irritating substances and organisms by the cryogenic, pure, inert Nitrogen gas eliminating or reducing damage to the health and well-being of the person involved.

23. A method of working bare handed with cryogenics and fires to one's safety and knowing the integrity of equipment and status of extinguishing the fire includes, for cryogenics, to know when the coldness is exposed to the outer surface so those areas are not included in your grasping the holder, and to know that a piece of equipment is worn out allowing the coldness to break through the dead space barrier having cryogenically cold gas or even liquid in contact with the outer surface and the action needed is to dispose of that item; and for fires, to know if substance that was burning and is now not showing flames is out, which is indicated by cold material, or smoldering and can reignite if still warm, and to know if the fire has penetrated the structure by warmness of walls, floor and other parts of the fire environment to treat those areas with the fire suppressant; and, for safety to one's hands, bare hands allow one to realize the coldness and letting go prevents the building up of heat or cold where, had gloves been used, in the concentration on the activity of the crisis, one might continue working as gloves build in coldness or heat until there is damage to the hands before the gloves have been removed.
